(19) United States
(12) Patent Application Publication
(10) Pub. No.: US 2026/0065923 A1
(43) Pub. Date: Mar. 5, 2026

(54) AUDIO NOISE REDUCTION PROCESSING METHOD AND APPARATUS, STORAGE MEDIUM, AND ELECTRONIC DEVICE

(71) Applicant: Tencent Technology (Shenzhen) Company Limited, Shenzhen (CN)

(72) Inventor: Huanbin ZOU, Shenzhen (CN)

(73) Assignee: Tencent Technology (Shenzhen) Company Limited, Shenzhen (CN)

(21) Appl. No.: 19/229,494

(22) Filed: Jun. 5, 2025

Related U.S. Application Data
(63) Continuation of application No. PCT/CN2024/099797, filed on Jun. 18, 2024.

(30) Foreign Application Priority Data
Aug. 30, 2023 (CN) 202311112850.6

(51) Int. Cl. G10L 21/0224; G10L 21/0232; G10L 25/30

(52) U.S. Cl. CPC G10L 21/0224; G10L 21/0232; G10L 25/30

(57) ABSTRACT

An audio noise reduction processing method and apparatus, a storage medium and an electronic device are disclosed. The method includes: obtaining an audio signal (S202); performing frequency domain transformation on the audio signal to obtain a noisy frequency domain representation (S204); and dividing the noisy frequency domain representation into N noisy frequency bands, and inputting the N noisy frequency bands respectively into N noise reduction branches in an audio processing network (S206); modulating the N branch mask estimation results by employing the noisy frequency domain representation, to obtain N speech frequency domain representations (S208); and performing time domain transformation on the N speech frequency domain representations, to obtain a speech signal free from noise signal interference in the audio signal (S210).

### RELATED APPLICATION

This application claims priority to Chinese Patent Application No. 202311112850.6, filed with the China National Intellectual Property Administration on Aug. 30, 2023, and PCT/CN2024/099797, filed on Jun. 18, 2024, which are both entitled “AUDIO NOISE REDUCTION PROCESSING METHOD AND APPARATUS, STORAGE MEDIUM, AND ELECTRONIC DEVICE” and incorporated herein by reference in their entireties.

### FIELD OF THE TECHNOLOGY

This application relates to the field of audio processing technologies, and in particular, to an audio noise reduction processing technology.

### BACKGROUND OF THE DISCLOSURE

Currently, to achieve speech enhancement and noise reduction for a noise-containing audio signal, a single sampling rate is usually employed for sampling the audio signal, followed by further processing based on a specific application scenario. For example, if a wide-band signal is processed by using a full-band speech enhancement method, the audio signal needs to be up-sampled, and a high-frequency component needs to be set to zero. However, this introduces unnecessary computational load. If a full-band signal is processed with a wide-band speech enhancement method, the audio signal needs to be down-sampled, which results in loss of high-frequency information.

To be specific, an audio noise reduction method provided in the related art has a problem of inaccurate noise reduction processing result.

For the aforementioned problem, no effective solution has been provided yet.

### SUMMARY

Embodiments of this disclosure provide an audio noise reduction processing method and apparatus, a storage medium, and an electronic device, to solve at least a technical problem of inaccurate audio noise reduction processing result.

According to one aspect of the embodiments of this disclosure, an audio noise reduction processing method is provided, which is performed by an electronic device, and includes:
obtaining a to-be-processed audio signal, the audio signal including a to-be-recognized speech signal interfered with by a noise signal;
performing frequency domain transformation on the audio signal to obtain a noisy frequency domain representation corresponding to the audio signal;
dividing the noisy frequency domain representation into N noisy frequency bands, and inputting the N noisy frequency bands respectively into N noise reduction branches in an audio processing network, to obtain N branch mask estimation results, an i^{th} noise reduction branch in the audio processing network being configured to process an i^{th} noisy frequency band among the N noisy frequency bands to obtain an i^{th} branch mask estimation result corresponding to the i^{th} noisy frequency band, the N noise reduction branches having a same signal processing structure, i being a natural number greater than or equal to 1 and less than or equal to N, and N being a natural number greater than 1;
modulating the N branch mask estimation results by employing the noisy frequency domain representation, to obtain N speech frequency domain representations; and
performing time domain transformation on the N speech frequency domain representations, to obtain a speech signal free from noise signal interference in the audio signal.

According to another aspect of the embodiments of this disclosure, an audio noise reduction processing apparatus is further provided, including:
an obtaining unit, configured to obtain a to-be-processed audio signal, the audio signal including a to-be-recognized speech signal interfered with by a noise signal;
an extraction unit, configured to perform frequency domain transformation on the audio signal, to obtain a noisy frequency domain representation corresponding to the audio signal;
an input unit, configured to divide the noisy frequency domain representation into N noisy frequency bands, and input the N noisy frequency bands respectively into N noise reduction branches in an audio processing network, to obtain N branch mask estimation results, an i^{th} noise reduction branch in the audio processing network being configured to process an i^{th} noisy frequency band among the N noisy frequency bands, to obtain an i^{th} branch mask estimation result corresponding to the i^{th} noisy frequency band, the N noise reduction branches having a same signal processing structure, i being a natural number greater than or equal to 1 and less than or equal to N, and N being a natural number greater than 1;
a modulation unit, configured to modulate the N branch mask estimation results by employing the noisy frequency domain representation, to obtain N speech frequency domain representations; and
a transformation unit, configured to perform time domain transformation on the N speech frequency domain representations, to obtain a speech signal free from noise signal interference in the audio signal.

According to still another aspect of the embodiments of this disclosure, a computer-readable storage medium is further provided, the computer-readable storage medium having a computer program stored therein, the computer program being configured to, when run, perform the foregoing audio noise reduction processing method.

According to still another aspect of the embodiments of this disclosure, a computer program product or a computer program is provided, the computer program product or the computer program including computer instructions, and the computer instructions being stored in a computer-readable storage medium. A processor of a computer device reads the computer instructions from the computer-readable storage medium, and executes the computer instructions, to cause the computer device to perform the foregoing audio noise reduction processing method.

According to still another aspect of the embodiments of this disclosure, an electronic device is further provided, including a memory and a processor, the memory having a computer program stored therein, the processor being configured to execute the computer program to perform the foregoing audio noise reduction processing method.

In the embodiments of this disclosure, the to-be-processed audio signal is obtained, where the audio signal includes the to-be-recognized speech signal interfered with by the noise signal. Then, frequency domain transformation is performed on the audio signal to obtain the noisy frequency domain representation corresponding to the audio signal. Subsequently, the noisy frequency domain representation is divided into the N noisy frequency bands, and the N noisy frequency bands are inputted respectively into the N noise reduction branches in the audio processing network, to obtain the N branch mask estimation results, where the i^{th} noise reduction branch in the audio processing network is configured to process the i^{th} noisy frequency band among the N noisy frequency bands, to obtain the i^{th} branch mask estimation result corresponding to the i^{th} noisy frequency band, the N noise reduction branches have a same signal processing structure, i is a natural number greater than or equal to 1 and less than or equal to N, and N is a natural number greater than 1. Further, the N branch mask estimation results are modulated by employing the noisy frequency domain representation, to obtain the N speech frequency domain representations. Accordingly, time domain transformation is performed on the N speech frequency domain representations, to obtain the speech signal free from the noise signal interference in the audio signal. In other words, in the embodiments of this disclosure, a plurality of noise reduction branches are employed to perform noise reduction processing respectively on a plurality of noisy frequency domain bands corresponding to the audio signal, to obtain the branch mask estimation results corresponding to different noisy frequency bands. Further, the noisy frequency domain representation is modulated by employing the branch mask estimation results, and time domain transformation is performed on the speech signal obtained by modulation, whereby the speech signal free from the noise signal interference is obtained. Compared with an audio signal processing model for a fixed sampling rate in the related art, in the embodiments of this disclosure, the plurality of noise reduction branches are employed simultaneously to perform noise reduction processing on the plurality of different noisy frequency bands, the corresponding speech signal is generated by using the obtained branch mask estimation results, and the speech signal free from the noise signal interference in a required frequency band can be directly obtained, whereby inaccuracy of the noise reduction result caused by interference introduced from an intermediate processing operation during noise reduction processing on the audio signal by employing the audio signal processing model can be avoided. Therefore, a technical effect for improving the accuracy of audio signal noise reduction processing is achieved.

### BRIEF DESCRIPTION OF THE DRAWINGS

The accompanying drawings described herein are used to provide a further understanding of this disclosure, and constitute part of this disclosure. Exemplary embodiments of this disclosure and descriptions thereof are used to explain this disclosure, and do not constitute any inappropriate limitation to this disclosure. In the accompanying drawings:

FIG. 1A and FIG. 1B are schematic diagrams of an application environment of an alternative audio noise reduction processing method according to an embodiment of this disclosure.

FIG. 2 is a flowchart of an alternative audio noise reduction processing method according to an embodiment of this disclosure.

FIG. 3 is a schematic diagram of an alternative audio noise reduction processing method according to an embodiment of this disclosure.

FIG. 4 is a schematic diagram of another alternative audio noise reduction processing method according to an embodiment of this disclosure.

FIG. 5 is a schematic diagram of still another alternative audio noise reduction processing method according to an embodiment of this disclosure.

FIG. 6 is a schematic diagram of still another alternative audio noise reduction processing method according to an embodiment of this disclosure.

FIG. 7 is a schematic diagram of still another alternative audio noise reduction processing method according to an embodiment of this disclosure.

FIG. 8 is a schematic diagram of still another alternative audio noise reduction processing method according to an embodiment of this disclosure.

FIG. 9 is a schematic diagram of still another alternative audio noise reduction processing method according to an embodiment of this disclosure.

FIG. 10 is a schematic diagram of still another alternative audio noise reduction processing method according to an embodiment of this disclosure.

FIG. 11 is a schematic diagram of still another alternative audio noise reduction processing method according to an embodiment of this disclosure.

FIG. 12 is a schematic diagram of still another alternative audio noise reduction processing method according to an embodiment of this disclosure.

FIG. 13 is a schematic diagram of still another alternative audio noise reduction processing method according to an embodiment of this disclosure.

FIG. 14 is a schematic structural diagram of still another alternative audio noise reduction processing apparatus according to an embodiment of this disclosure.

FIG. 15 is a schematic structural diagram of still another alternative electronic device according to an embodiment of this disclosure.

### DESCRIPTION OF EMBODIMENTS

In order to make a person skilled in the art better understand solutions of this disclosure, the following clearly and completely describes the technical solutions in embodiments of this disclosure with reference to the accompanying drawings in the embodiments of this disclosure. Apparently, the described embodiments are only some of the embodiments of this disclosure rather than all of the embodiments. All other embodiments obtained by a person of ordinary skill in the art based on the embodiments of this disclosure without creative efforts may fall within the protection scope of this disclosure.

In addition, in the specification, claims, and accompanying drawings of this disclosure, the terms “first”, “second”, and the like are intended to distinguish similar objects but do not necessarily indicate a specific order or sequence. Such used data is interchangeable where appropriate, whereby the embodiments of this disclosure described herein can be implemented in an order other than those illustrated or described here. Moreover, the terms “include”, “contain” and any other variants mean to cover the non-exclusive inclusion, for example, a process, a method, a system, a product, or a device that includes a list of steps or units is not necessarily limited to those expressly listed steps or units, but may include other steps or units not expressly listed or inherent to such a process, a method, a system, a product, or a device.

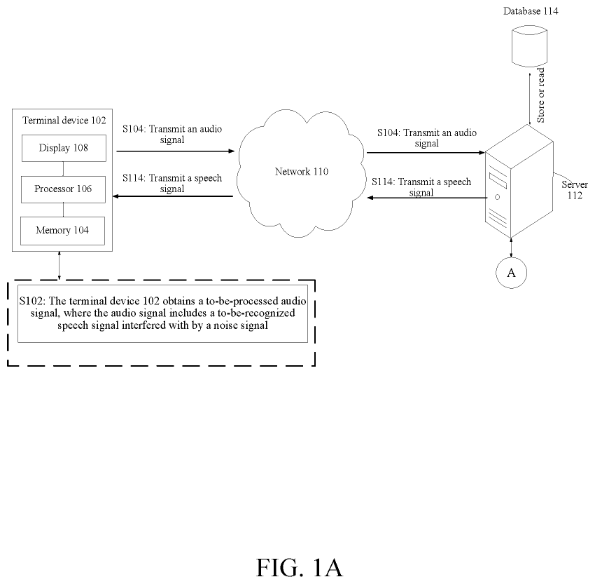

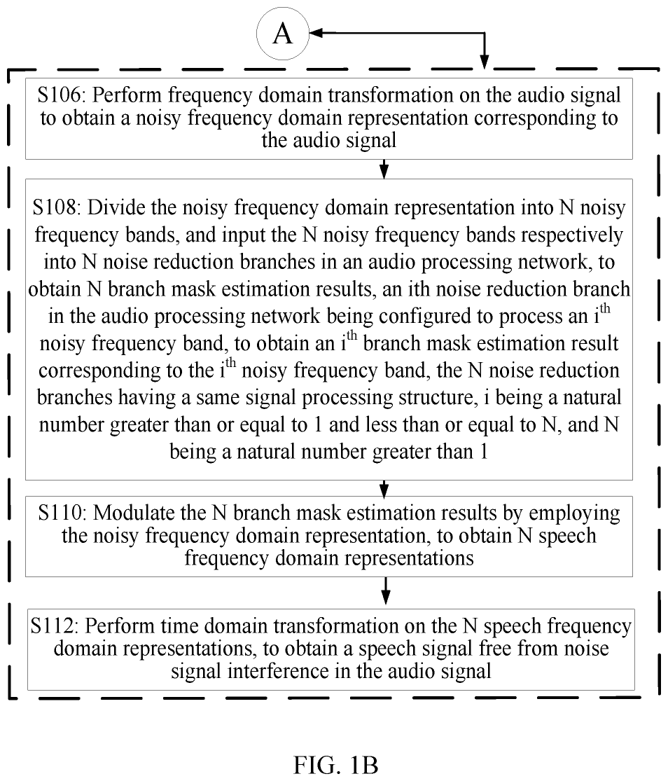

According to one aspect of the embodiments of this disclosure, an audio noise reduction processing method is provided. In some embodiments, as an alternative implementation, the audio noise reduction processing method may be applicable to, but not limited to, an environment shown in FIG. 1A and FIG. 1B. As shown in FIG. 1A and FIG. 1B, a terminal device 102 includes a memory 104 (configured to store various data generated during operation of the terminal device 102), a processor 106 (configured to process and calculate the data), and a display 108. The terminal device 102 may exchange data with a server 112 over a network 110. The server 112 is connected with a database 114, and the database 114 is configured to store various data.

Further, a corresponding specific disclosure process of the foregoing method in the environment shown in FIG. 1A and FIG. 1B is shown as the following operations:

Operations S102 to S104 are performed. The terminal device 102 obtains a to-be-processed audio signal, where the audio signal includes a to-be-recognized speech signal interfered with by a noise signal. The terminal device 102 transmits the audio signal to the server 112 through the network 110.

Subsequently, operations S106 to S112 are performed. The server 112 performs frequency domain transformation on the audio signal to obtain a noisy frequency domain representation corresponding to the audio signal. The server 112 divides the noisy frequency domain representation into N noisy frequency bands, and inputs the N noisy frequency bands respectively into N noise reduction branches in an audio processing network, to obtain N branch mask estimation results, where an i^{th} noise reduction branch in the audio processing network is configured to process an i^{th} noisy frequency band to obtain an i^{th} branch mask estimation result corresponding to the i^{th} noisy frequency band, the N noise reduction branches have a same signal processing structure, i is a natural number greater than or equal to 1 and less than or equal to N, and N is a natural number greater than 1. The server 112 performs modulation processing on the N branch mask estimation results by employing the noisy frequency domain representation, to obtain N speech frequency domain representations. The server 112 performs time domain transformation on the N speech frequency domain representations, to obtain a speech signal free from noise signal interference in the audio signal.

Subsequently, operation S114 is performed. The server 112 transmits the speech signal to the terminal device 102 through the network 110.

In the embodiments of this disclosure, the to-be-processed audio signal is obtained, where the audio signal includes the to-be-recognized speech signal interfered with by the noise signal. Then, frequency domain transformation is performed on the audio signal to obtain the noisy frequency domain representation corresponding to the audio signal. Subsequently, the noisy frequency domain representation is divided into the N noisy frequency bands, and the N noisy frequency bands are inputted respectively into the N noise reduction branches in the audio processing network, to obtain the N branch mask estimation results, where the i^{th} noise reduction branch in the audio processing network is configured to process the i^{th} noisy frequency band among the N noisy frequency bands, to obtain the i^{th} branch mask estimation result corresponding to the i^{th} noisy frequency band, the N noise reduction branches have a same signal processing structure, i is a natural number greater than or equal to 1 and less than or equal to N, and N is a natural number greater than 1. Further, the N branch mask estimation results are modulated by employing the noisy frequency domain representation, to obtain the N speech frequency domain representations. Accordingly, time domain transformation is performed on the N speech frequency domain representations, to obtain the speech signal free from the noise signal interference in the audio signal. In other words, in the embodiments of this disclosure, a plurality of noise reduction branches are employed to perform noise reduction processing respectively on a plurality of noisy frequency domain bands corresponding to the audio signal, to obtain the speech signal free from the noise signal interference. Consequently, the problem in the related art that the noise reduction processing result obtained by employing an audio signal processing model of a fixed sampling rate to perform noise reduction processing on the audio signal is inaccurate can be avoided. Therefore, a technical effect for improving the accuracy of audio signal noise reduction processing is achieved.

Alternatively, in the present embodiment, the foregoing terminal device may be a terminal device provided with a target client, and may include, but is not limited to, at least one of the following: a mobile phone (such as an Android mobile phone, or an iOS mobile phone), a notebook computer, a tablet computer, a palmtop computer, a mobile Internet device (MID), a PAD, a desktop computer, or a smart TV. The target client may be a video client, an instant messaging client, a browser client, an education client, or the like. The foregoing network may include, but is not limited to: a wired network and a wireless network. The wired network includes: a local area network, a metropolitan area network, and a wide area network, and the wireless network includes: Bluetooth, WIFI, and other networks implementing the wireless communication. The server may be a single server, a server cluster including a plurality of servers, or a cloud server. The aforementioned description is merely an example. This is not limited in the present embodiment.

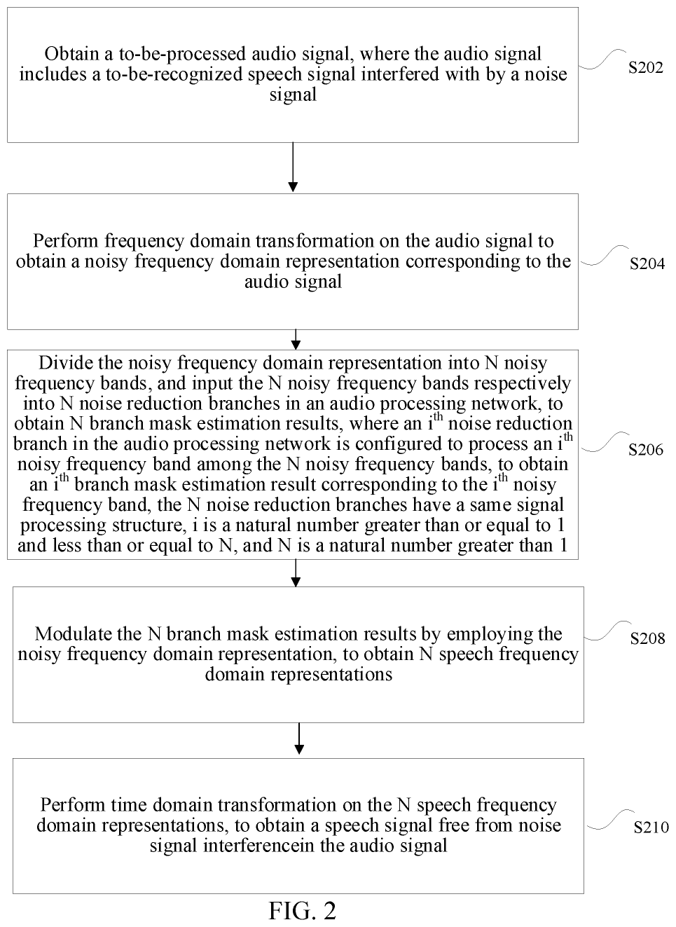

Alternatively, as an alternative implementation, as shown in FIG. 2, the foregoing audio noise reduction processing method may be performed by an electronic device, and the method includes:
S202: Obtain a to-be-processed audio signal, the audio signal including a to-be-recognized speech signal interfered with by a noise signal;
S204: Perform frequency domain transformation on the audio signal to obtain a noisy frequency domain representation corresponding to the audio signal;
S206: Divide the noisy frequency domain representation into N noisy frequency bands, and input the N noisy frequency bands respectively into N noise reduction branches in an audio processing network, to obtain N branch mask estimation results, where an i^{th} noise reduction branch in the audio processing network is configured to process an i^{th} noisy frequency band among the N noisy frequency bands, to obtain an i^{th} branch mask estimation result corresponding to the i^{th} noisy frequency band, the N noise reduction branches have a same signal processing structure, i is a natural number greater than or equal to 1 and less than or equal to N, and N is a natural number greater than 1;
S208: Modulate the N branch mask estimation results by employing the noisy frequency domain representation, to obtain N speech frequency domain representations; and
S210: Perform time domain transformation on the N speech frequency domain representations, to obtain a speech signal free from noise signal interference in the audio signal.

In addition, the audio noise reduction processing method may be applied to but is not limited to a scenario of audio signal noise reduction processing of a voice call, a video call, a video conference, a camera device, an intelligent household appliance, or the like. Assuming that the audio noise reduction processing method is applied to the noise reduction processing scenario of an audio signal of the voice call, the foregoing method may be configured for performing noise reduction processing on the audio signal collected during the voice call, to obtain the speech signal free from the noise interference. Assuming that the audio noise reduction processing method is applied to the noise reduction processing scenario of an audio signal of the camera device, the foregoing method may be configured for performing noise reduction processing on the audio signal collected by the camera device, to obtain the speech signal free from the noise interference. Assuming that the audio noise reduction processing method is applied to the noise reduction processing scenario of an audio signal of the intelligent household appliance, the foregoing method may be configured for performing noise reduction processing on the audio signal collected by the intelligent household appliance, to obtain the speech signal free from the noise interference.

Further, the audio signal may be, but is not limited to an original speech signal collected by the terminal device. The speech signal includes useless noise and a to-be-extracted speech signal. For example, assuming that the audio noise reduction processing method is applied to the noise reduction processing scenario of the audio signal of the voice call, and a user object A is currently in a call with a user object B via a terminal device a, the audio signal may be an audio signal that is collected by the terminal device a from an environment in which the user object A is located, and the audio signal includes noise existing in the environment in which the user object A is located and a voice produced by the user object A.

Alternatively, in the present embodiment, before the operation of performing frequency domain transformation on the audio signal, to obtain a noisy frequency domain representation corresponding to the audio signal, the method may include but is not limited to: framing and windowing processing is performed on the audio signal, to prevent spectrum leakage. For example, the audio signal may be, but not limited to being, segmented into multiple frames of short signals with a fixed length (i.e., 1024), with each frame including 1024 sampling points (i.e., a frame length of 1024) and a frame shift of 512 (i.e., an overlap length of 512 between two adjacent frames). Specifically, The 1024 sampling points starting from a start audio point of the audio signal may be used as a first frame of short signal obtained by framing, and then the first frame of short signal is shifted backward by 512 sampling points; and the 1024 sampling points starting from the 513th sampling point of the audio signal may be used as a second frame of short signal obtained by framing; and this process is iteratively repeated until all sampling points in the audio signal are framed into the corresponding short signals. Further, a Hamming window is employed to perform modulation processing on each frame of the audio signal, which prevents the spectrum leakage.

In addition, a windowing processing manner for windowing the audio signal is not limited to the Hamming window, and may further employ other manners such as a rectangular window or a Hanning window. This is not limited in the present embodiment.

Further, the operation of performing frequency domain transformation on the audio signal, to obtain a noisy frequency domain representation corresponding to the audio signal may include but is not limited to: a discrete cosine transform (DCT) operation is performed on the audio signal after the framing and windowing processing to obtain a noisy frequency domain feature of the audio signal. In addition, a process of performing the framing and windowing processing and the discrete cosine transform operation on the audio signal is actually a process of performing short-time discrete cosine transform (SDCT) on the audio signal.

In addition, after performing the framing and windowing processing on the audio signal, another method may alternatively be employed to obtain the noisy frequency domain representation corresponding to the audio signal. For example, a short-time Fourier transform (STFT) method may be used. In addition, in the present embodiment, after the framing and windowing processing is performed on the audio signal, the audio signal may further be transformed into other acoustic features for analysis, such as an amplitude spectrum, a power spectrum, and a Mel spectrum. This is not limited in the present embodiment.

Specifically, (1) the short-time Fourier transform (STFT) is a mathematical transform related to Fourier transform, and is configured to determine a frequency and a phase of a sine wave of a local region of a time-varying signal. A core logic is to select a time-frequency localization window function. Assuming that the analysis window function g (t) is stationary (pseudo-stationary) within a short time interval, the window function is shifted to make f (t) and g (t) be stationary signals within different finite time intervals, whereby the power spectrum at various different moments is calculated.

2) The discrete cosine transform is a transform related to Fourier transform, which is similar to the discrete Fourier transform (DFT), but only uses a real number. The discrete cosine transform is equivalent to discrete Fourier transform whose length is approximately twice that of the discrete cosine transform. The discrete Fourier transform is performed on a real even function (because a Fourier transform of a real even function is still a real even function), and in some variations, an input position or an output position needs to be shifted by half a unit. A basic principle of the discrete cosine transform formula is to transform a time-domain signal x (n) having a length of N into a frequency-domain signal X (k) having a length of N, where k represents a frequency. An expression of the discrete cosine transform formula is: X(k)=Σ[n=0, N−1]×(n)cos [(π/N) (n+½)k], where k=0, 1, 2, . . . , N−1. The formula may be considered as a cosine function-based Fourier transform, and is configured to decompose a time-domain signal into a weighted sum of a series of cosine functions, to obtain a frequency domain signal.

3) The amplitude spectrum is a curve of a signal amplitude and a frequency (angular frequency). In the frequency domain description of a signal, a frequency function with the frequency as an independent variable and an amplitude of each frequency component constituting the signal as a dependent variable is referred to as the amplitude spectrum, which characterizes a distribution of the signal amplitude with the frequency. For the frequency-domain description of different signals, the power spectrum is usually used, which characterizes a distribution of signal energy with the frequency.

4) The power spectrum is an abbreviation of a power spectrum density function, and is defined as signal power within a unit frequency band. It represents the variation of signal power with the frequency, i.e., the distribution of signal power in the frequency domain. The power spectrum represents a relationship between the signal power and the frequency variation.

5) The Mel spectrum is a spectrum obtained by transforming a frequency into a Mel scale. The Mel spectrum can adapt to hearing of human ears and is widely applied to the speech field.

Further, assuming that a sampling rate of the audio signal is 48 kHz, a sampling rate range of the noisy frequency domain representation is [0 kHz, 24 kHz]. The operation of dividing the noisy frequency domain representation into N noisy frequency bands may include but is not limited to: the noisy frequency domain representation is divided into a noisy low frequency band [0, 8 kHz] and a noisy high frequency band (8 kHz, 24 kHz], or the noisy frequency domain representation is divided into a noisy frequency band [0, 8 kHz], a noisy frequency band (8 kHz, 16 kHz], and a noisy frequency band (16 kHz, 24 kHz]. This is not limited in the present embodiment.

In addition, assuming that the N noisy frequency bands include: the noisy low frequency band [0, 8 kHz] and the noisy high frequency band (8 kHz, 24 kHz], the audio processing network including the N noise reduction branches may include but is not limited to: a two-way audio processing network in which modeling analysis is performed respectively based on audios in the low frequency band [0, 8 kHz] and the high frequency band (8 kHz, 24 kHz]. Assuming that the N noisy frequency bands include: the noisy frequency band [0, 8 kHz], the noisy frequency band (8 kHz, 16 kHz], and the noisy frequency band (16 kHz, 24 kHz], the audio processing network including the N noise reduction branches may include but is not limited to: a three-way audio processing network in which the modeling analysis is performed respectively based on audios in [0, 8 kHz], (8 kHz, 16 kHz] and (16 kHz, 24 kHz].

Alternatively, in the embodiments of this disclosure, the audio processing network may, but is not limited to, adopt an encoder-decoder interaction structure. Specifically, assuming that the N noisy frequency bands include: the noisy low frequency band [0, 8 kHz] and the noisy high frequency band (8 kHz, 24 kHz], the audio processing network includes two branches, which are respectively a low frequency branch obtained by training based on audio information in the low frequency band [0, 8 kHz] and a high frequency branch obtained by training based on the audio information in the high frequency band (8 kHz, 24 kHz]. In addition, the audio processing network further includes a gated structure configured to transfer information from the low frequency branch to the high frequency branch. The low frequency branch and the high frequency branch may adopt the encoder-decoder interaction structure. In addition, the audio processing network may alternatively employ another structure, and is not limited to the encoder-decoder interaction structure. This is not limited in the present embodiment.

In the embodiments of this disclosure, the branch mask estimation results are obtained by processing the corresponding noisy frequency bands by employing the noise reduction branches in the audio processing network. The branch mask estimation results may be configured for indicating effectiveness of features at positions in the noisy frequency bands. For example, for a noisy frequency band, a position corresponding to a noise signal in the corresponding branch mask estimation result is indicated as invalid, whereas a position corresponding to a user-produced speech signal is indicated as valid.

Alternatively, in the present embodiment, the operation of modulating the N branch mask estimation results by employing the noisy frequency domain representation, to obtain N speech frequency domain representations may include but is not limited to: a cross multiplication operation is performed on the noisy frequency domain representation and the N branch mask estimation results, to obtain the speech frequency domain representations of N branch masks. The modulation based on the noisy frequency domain representation and the N branch mask estimation results may be essentially understood as enhancing features corresponding to the user-produced speech signal in the noisy frequency domain representation by employing the branch mask estimation results and eliminating or weakening noise features in the noisy frequency domain representation, and consequently frequency domain denoising processing is achieved.

Alternatively, in the present embodiment, the operation of performing time domain transformation on the N speech frequency domain representations, to obtain a speech signal free from noise signal interference in the audio signal may include but is not limited to: short-time discrete cosine transform processing is performed on each speech frequency domain representation, to obtain the corresponding speech signal free from the noise interference. Certainly, in an actual application, another time domain transformation manner may alternatively be adopted to transform the speech frequency domain representation into a corresponding time domain speech signal. The adopted time domain transformation manner may correspond to the foregoing adopted frequency domain transformation manner. The adopted time domain transformation manner is not limited in the embodiments of this disclosure.

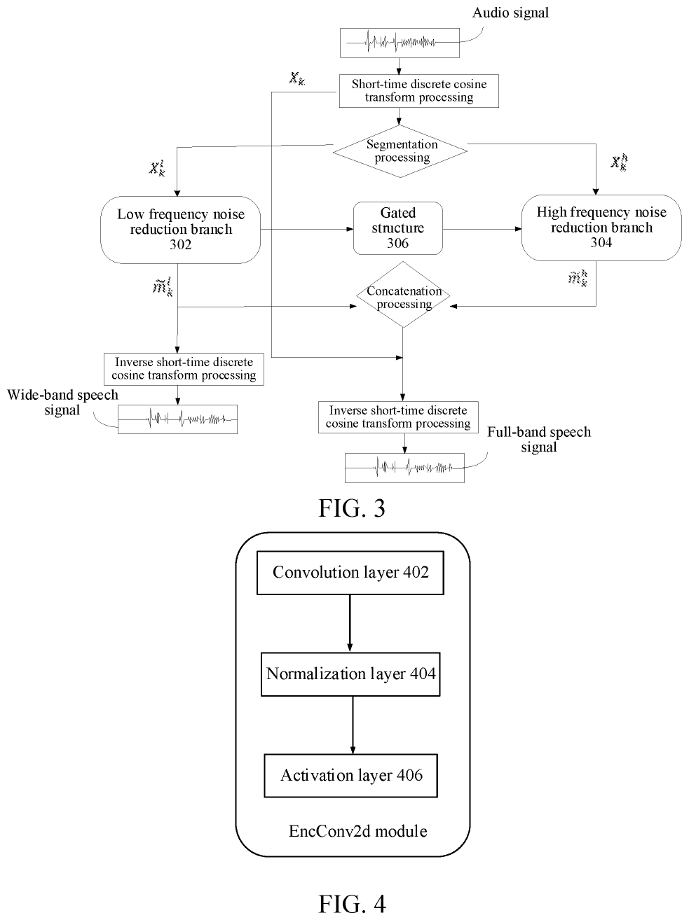

As an alternative implementation, by using an example in which the noisy frequency domain representation is divided into two noisy frequency bands, i.e., respectively the noisy low frequency band [0, 8 kHz] and the noisy high frequency band (8 kHz, 24 kHz], the foregoing method is described by taking the following operations shown in FIG. 3 as an example:
a noise-containing audio signal is obtained, and short-time discrete cosine transform processing is performed on the audio signal to obtain a frequency domain feature Xₖ of the audio signal, i.e., the above noisy frequency domain representation. Subsequently, the frequency domain feature Xₖ is segmented to obtain the noisy low frequency band

$${X}_{k}^{l}$$

and the noisy high frequency band

$${X}_{k}^{h} .$$

Then, the noisy low frequency band

$${X}_{k}^{l}$$

is inputted to a low frequency noise reduction branch 302 for processing to obtain a mask estimation result

$${\tilde{m}}_{k}^{l}$$

corresponding to the noisy low frequency band. Further, the modulation processing is performed based on

$${\tilde{m}}_{k}^{l} and {X}_{k}^{l}$$

to obtain a modulation result, and then inverse short-time discrete cosine transform processing is performed on the modulation result, to obtain a wide-band speech signal free from noise interference.

The noisy high frequency band

$${X}_{k}^{h}$$

is inputted to a high frequency noise reduction branch 304 for processing, and data in the low frequency noise reduction branch 302 is modulated by employing a gated structure 306 to obtain instructions for assisting the operation of the high frequency noise reduction branch 304, to obtain a mask estimation result

$${\tilde{m}}_{k}^{h}$$

corresponding to the noisy nigh frequency band. Further, the mask estimation result

$${\tilde{m}}_{k}^{h}$$

and the mask estimation result

$${\tilde{m}}_{k}^{l}$$

are concatenated, the concatenated mask estimation result and Xₖ are modulated to obtain a modulation result, the inverse short-time discrete cosine transform processing is performed on the modulation result to obtain a full-band speech signal free from noise interference.

In the embodiments of this disclosure, the to-be-processed audio signal is obtained, where the audio signal includes the to-be-recognized speech signal interfered with by the noise signal. Then, frequency domain transformation is performed on the audio signal to obtain the noisy frequency domain representation corresponding to the audio signal. Subsequently, the noisy frequency domain representation is divided into the N noisy frequency bands, and the N noisy frequency bands are inputted respectively into the N noise reduction branches in the audio processing network, to obtain the N branch mask estimation results, where the i^{th} noise reduction branch in the audio processing network is configured to process the i^{th} noisy frequency band among the N noisy frequency bands, to obtain the i^{th} branch mask estimation result corresponding to the i^{th} noisy frequency band, the N noise reduction branches have a same signal processing structure, i is a natural number greater than or equal to 1 and less than or equal to N, and N is a natural number greater than 1. Further, the N branch mask estimation results are modulated by employing the noisy frequency domain representation, to obtain the N speech frequency domain representations. Accordingly, time domain transformation is performed on the N speech frequency domain representations, to obtain the speech signal free from the noise signal interference from the audio signal. In other words, in the embodiments of this disclosure, a plurality of noise reduction branches are employed to perform noise reduction processing respectively on a plurality of noisy frequency domain bands corresponding to the audio signal, to obtain the branch mask estimation results corresponding to different noisy frequency bands. Further, the noisy frequency domain representation is modulated by employing the branch mask estimation results, and time domain transformation is performed on the speech signal obtained by modulation, whereby the speech signal free from the noise signal interference is obtained. Compared with an audio signal processing model for a fixed sampling rate in the related art, in the embodiments of this disclosure, the plurality of noise reduction branches are employed simultaneously to perform noise reduction processing on the plurality of different noisy frequency bands, the corresponding speech signal is generated by using the obtained branch mask estimation results, and the speech signal free from the noise signal interference in a required frequency band can be directly obtained, whereby inaccuracy of the noise reduction result caused by interference introduced from an intermediate processing operation during noise reduction processing on the audio signal by employing the audio signal processing model can be avoided. Therefore, a technical effect for improving the accuracy of audio signal noise reduction processing is achieved.

As an alternative solution, the operation of inputting the N noisy frequency bands respectively into N noise reduction branches in an audio processing network, to obtain N branch mask estimation results includes:
the following operation is performed on the i^{th} noisy frequency band in the i^{th} noise reduction branch:
S1: Perform feature dimension transformation on the i^{th} noisy frequency band, to obtain an i^{th} noisy feature vector with a target feature length;
S2: Perform noise reduction processing on the i^{th} noisy feature vector, to obtain an i^{th} noise reduction result;
S3: Perform inverse feature dimension transformation on the i^{th} noise reduction result, to obtain an i^{th} branch processing result with a feature length the same as that of the i^{th} noisy frequency band; and
S4: Perform a mask estimation operation on the i^{th} branch processing result, to obtain the i^{th} branch mask estimation result corresponding to the i^{th} noisy frequency band.

Alternatively, in the present embodiment, it is assumed that the noisy frequency domain representation is divided into two noisy frequency bands, i.e., respectively the noisy low frequency band and the noisy high frequency band, where a frequency in the noisy high frequency band is higher than a frequency in the noisy low frequency band, and sampling points corresponding to the noisy high frequency band are more than the sampling points corresponding to the noisy low frequency band. For the noisy low frequency band, the operation of performing feature dimension transformation on the noisy low frequency band, to obtain a noisy feature vector with a target feature length may include but is not limited to: feature dimension transformation is performed on the noisy low frequency band, and the feature vector obtained after the dimension change is amplified to obtain the noisy feature vector with the target feature length. For the noisy high frequency band, the operation of performing feature dimension transformation on the noisy high frequency band, to obtain a noisy feature vector with a target feature length may include but is not limited to: feature dimension transformation is performed on the noisy high frequency band, and the feature vector obtained after the dimension change is compressed to obtain the noisy feature vector with the target feature length. In other words, in the present embodiment, feature dimension processing is performed respectively on the noisy feature vectors corresponding to the noisy frequency bands, whereby the noisy feature vectors respectively corresponding to the frequency bands have the same feature length, which ensures that the noise reduction branches respectively corresponding to the frequency bands may perform information interaction with one another.

Further, in addition, a network structure of each noise reduction branch of the N noise reduction branches may be but are not limited to being completely the same. Specifically, the noise reduction branches may include but are not limited to:
1) a fully-connected feature dimension transformation Dense input layer, configured to adjust a dimension of the noisy feature vector corresponding to the noisy frequency band;
2) an encoder module, configured to reduce a frequency domain feature dimension of the noisy feature vector, but keep a time domain feature dimension of the noisy feature vector unchanged, to reduce a calculation amount. Specifically, the encoder module may be, but is not limited to, formed by stacking EncConv2d modules layer by layer. Specifically, each EncConv2d module includes a convolution layer (i.e., two-dimensional convolution (Conv2d)), a normalization layer (i.e., normalization (BatchNorm)), and an activation layer (i.e., an activation function (PReLU)). A convolution kernel size of each layer of the EncConv2d is (5, 2), which represents that a field of view in the frequency domain is 5, and a field of view in the time domain is 2. To be specific, for the analysis and processing on each frame of signal features, refer to a preceding frame of signal, which may be considered as a streaming convolution structure, which ensures the network causality. A stride of the convolution may be, but is not limited to, set to (2, 1); and to be specific, a frequency domain stride of the convolution is 2, and a time domain stride is 1. In this way, a quantity of frequency domain features of the signal can be halved layer by layer, and the time domain feature dimension remains unchanged, which not only keeps time domain continuity of the information, but also can reduce the calculation amount;
3) an extraction module, configured to extract time sequence information in an output result of the encoder, where the extraction module may be a recurrent neural network (RNN) formed by stacking gated recurrent units (GRU), or may be another type of neural network, such as an attention mechanism (such as residual convolution and attention, abbreviated as RA) or a two-layer long short-term memory network (LSTM), and this is not limited in the present embodiment, where the RNN is a type of neural network having a short-term memory capability. In the RNN, a neuron not only may receive information from other neurons, but also may receive own information, to form a network structure with a loop. Compared with a feed-forward neural network, the RNN better conforms to a structure of a biological neural network. The RNN is widely applied to tasks such as speech recognition, language models, and natural language generation. The RA is an attention model based on the neural network, and is configured to process an image with a variable size and direction. The RA aims to imitate the attention mechanism of a human visual system, namely, focus the sight on different parts of the image at different time points, to perform more in-depth processing on the image. The LSTM is a variant of the recurrent neural network (RNN), and is applicable to a modeling task of a plurality of time sequences or sequence data. The basic structure includes three gates, i.e., an input gate, a forget gate, and an output gate, and a memory unit;
4) a decoder module, configured to restore a frequency domain feature quantity of the noisy feature vector, where the decoder module may be, but is not limited to, formed by staking DecTConv2d modules. The DecTConv2d module is highly similar to the EncConv2d module, and includes: a transposed convolution layer (i.e., a transposed convolution network (ConvTranspose2d)) corresponding to the convolution layer (i.e., two-dimensional convolution (Conv2d)) in the EncConv2d, a normalization layer (i.e., normalization (BatchNorm)), and an activation layer (i.e., an activation function (PReLU)). The number of layers of the DecTConv2d included in the decoder is the same as the number of layers of the EncConv2d included in the encoder. Parameters of each layer of the DecTConv2d are further the same as parameters of a corresponding layer of the EncConv2d. In addition, an output of each layer of the encoder may further be used as an influencing parameter of a corresponding layer in the decoder in a hopping connection manner, whereby layer-by-layer restoration of the signal feature dimension is achieved; and
5) a fully-connected feature dimension transformation Dense output layer, configured to restore a dimension of the noisy feature vector corresponding to the noisy frequency band.

As an alternative embodiment, it is assumed that the noisy frequency domain representation is divided into two noisy frequency bands, which are respectively the noisy low frequency band [0, 8 kHz] and the noisy high frequency band (8 kHz, 24 kHz]. Using an example in which the i^{th} noisy frequency band is the noisy low frequency band, the method is described by taking the following operations as an example:

Feature dimension transformation is performed on the noisy low frequency band by employing the Dense input layer, and the feature vector with an original feature length of 342 corresponding to the noisy low frequency band is amplified to a noisy feature vector with a feature length of 512, where the original feature length corresponding to the noisy low frequency band is determined based on a quantity of frequency points corresponding to the noisy low frequency band. Subsequently, noise reduction processing is performed on the noisy feature vector by employing the encoder module, the extraction module, and the decoder module, to obtain a noise reduction result. Then, inverse feature dimension transformation is performed on the noise reduction result with the feature length of 512 by employing the Dense output layer, to obtain a branch processing result with a feature length of 342. Further, a mask estimation operation is performed on the branch processing result with the feature length of 342, to obtain a mask estimation result matching the noisy low frequency band.

As an alternative embodiment, it is assumed that the noisy frequency domain representation is divided into two noisy frequency bands, which are respectively the noisy low frequency band [0, 8 kHz] and the noisy high frequency band (8 kHz, 24 kHz]. Using an example in which the i^{th} noisy frequency band is the noisy high frequency band, the method is described by taking the following operations as an example:

Feature dimension transformation is performed on the noisy high frequency band by employing the Dense input layer, and the feature vector with an original feature length of 682 corresponding to the noisy high frequency band is compressed to a noisy feature vector with a feature length of 512, where the original feature length corresponding to the noisy high frequency band is determined based on a quantity of frequency points corresponding to the noisy high frequency band. Subsequently, noise reduction processing is performed on the noisy feature vector by employing the encoder module, the extraction module, and the decoder module, to obtain a noise reduction result. Then, inverse feature dimension transformation is performed on the noise reduction result with the feature length of 512 by employing the Dense output layer, to obtain a branch processing result with a feature length of 682. Further, a mask estimation operation is performed on the branch processing result with the feature length of 682, to obtain a mask estimation result matching the noisy high frequency band.

In the embodiments of this disclosure, the following operation is performed on the i^{th} noisy frequency band in the i^{th} noise reduction branch: feature dimension transformation is performed on the i^{th} noisy frequency band, to obtain the i^{th} noisy feature vector with the target feature length. Then, the noise reduction processing is performed on the i^{th} noisy feature vector, to obtain the i^{th} noise reduction result; and the inverse feature dimension transformation is performed on the i^{th} noise reduction result, to obtain the i^{th} branch processing result with a feature length the same as that of the i^{th} noisy frequency band. Further, the mask estimation operation is performed on the i^{th} branch processing result, to obtain the i^{th} branch mask estimation result corresponding to the i^{th} noisy frequency band. In other words, in the embodiments of this disclosure, by performing dimension transformation on the noisy frequency bands, the feature lengths of the noisy feature vectors corresponding to different noisy frequency bands may be unified, to facilitate the interaction between the noisy feature vectors corresponding to respective noisy frequency bands during subsequent noise reduction processing, provide instruction for the processing of other noise reduction branches, and consequently improve a noise reduction effect. To be specific, the obtained branch mask estimation results can accurately distinguish and characterize a valid speech signal from an invalid noise signal.

As an alternative solution, the operation of performing noise reduction processing on the i^{th} noisy feature vector, to obtain an i^{th} noise reduction result includes:
S1: Encode the i^{th} noisy feature vector by employing an encoding network constructed based on a streaming convolution structure, to obtain an i^{th} encoded result;
S2: Analyze the i^{th} encoded result by employing the recurrent neural network constructed based on the gated recurrent units, to obtain an i^{th} intermediate result carrying time sequence information; and
S3: Decode the i^{th} intermediate result by employing a decoding network constructed based on the streaming convolution structure, to obtain the i^{th} noise reduction result, where a sub-network in the decoding network is obtained by adjusting a sub-network in the encoding network.

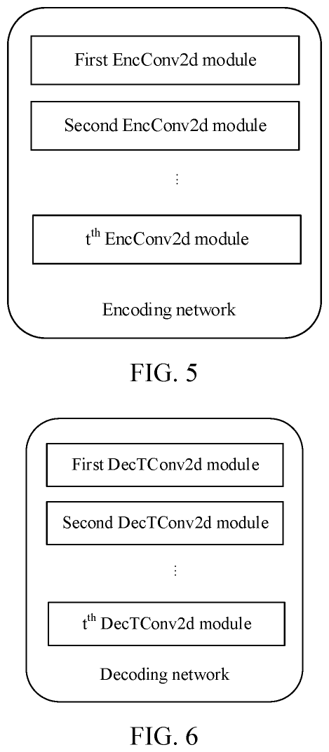

In addition, the encoding network constructed based on the streaming convolution structure may be, but is not limited to, configured to indicate the encoder module. Specifically, the encoder module may be, but is not limited to, configured to reduce the frequency domain feature dimension of the noisy feature vector, but keep the time domain feature dimension of the noisy feature vector unchanged, to reduce the calculation amount. Specifically, the encoder module may be, but is not limited to, formed by stacking EncConv2d modules layer by layer. The structure of the EncConv2d module is shown in FIG. 4, and includes a convolution layer 402 (i.e., two-dimensional convolution (Conv2d)), a normalization layer 404 (i.e., normalization (BatchNorm)), and an activation layer 406 (i.e., an activation function (PReLU)). A convolution kernel size of each layer of the EncConv2d is (5, 2), which represents that a field of view in the frequency domain is 5, and a field of view in the time domain is 2. To be specific, for the analysis and processing on each frame of signal features, refer to a preceding frame of signal, which may be considered as a streaming convolution structure, which ensures the network causality. A stride of the convolution may be, but is not limited to, set to (2, 1); and to be specific, a frequency domain stride of the convolution is 2, and a time domain stride is 1. In this way, a quantity of frequency domain features of the signal can be halved layer by layer, and the time domain feature dimension remains unchanged, which not only keeps time domain continuity of the information, but also can reduce the calculation amount. For example, assuming that the encoding network is an encoder module, the structure of the encoding network may, but is not limited to, as shown in FIG. 5, include t EncConv2d modules, where t is a positive integer greater than 2.

In addition, the recurrent neural network constructed based on the gated recurrent units may be, but is not limited to, configured to indicate the extraction module. Specifically, the extraction module may be a recurrent neural network (RNN) formed by stacking the gated recurrent units (GRU), and is configured to extract the time sequence information from an output result of the encoder module.

In addition, the foregoing decoding network constructed based on the streaming convolution structure may be, but is not limited to, configured to indicate the foregoing decoder module. Specifically, the decoder module is configured to restore a frequency domain feature quantity of the noisy feature vector. The decoder module may include, but is not limited to, a stack of DecTConv2d modules. The structure of DecTConv2d is highly similar to that of EncConv2d, and includes: a transposed convolution layer (i.e., a transposed convolution network (ConvTranspose2d)) corresponding to the convolution layer (i.e., two-dimensional convolution (Conv2d)) in the EncConv2d, a normalization layer (i.e., normalization (Batch Norm)), and an activation layer (i.e., an activation function (PReLU)). The number of DecTConv2d modules included in the decoder module is the same as the number of EncConv2d modules included in the encoder module. Parameters of each DecTConv2d module are further the same as parameters of the corresponding EncConv2 module. In addition, an output of each EncConv2d may further be used as an influencing parameter of the corresponding DecTConv2d in the decoder module in a hopping connection manner, whereby layer-by-layer restoration of the signal feature dimension is achieved. For example, it is assumed that the decoding network is the decoder module, and a structure of the decoding network may, but is not limited to, as shown in FIG. 6, include t DecTConv2d modules, where t is a positive integer greater than 2.

As an alternative embodiment, by using an example in which the noisy frequency domain representation is divided into two noisy frequency bands, i.e., respectively the noisy low frequency band [0, 8 kHz] and the noisy high frequency band (8 kHz, 24 kHz], the foregoing method is described by taking the following operations as an example:

The noisy feature vector corresponding to the noisy low frequency band is encoded by the encoder module in the low frequency noise reduction branch, to obtain a first encoded result. Then, the first encoded result is analyzed by employing the RNN in the low frequency noise reduction branch, to obtain a first intermediate result carrying the time sequence information. Further, the first intermediate result is decoded by the decoder module in the low frequency noise reduction branch to obtain a first noise reduction result.

Subsequently, the noisy feature vector corresponding to the noisy high frequency band is encoded by the encoder module in the high frequency noise reduction branch to obtain a second encoded result. Then, the second encoded result is analyzed by employing the RNN in the high frequency noise reduction branch, to obtain a second intermediate result carrying the time sequence information. Further, the second intermediate result is decoded by the decoder module in the high frequency noise reduction branch to obtain a second noise reduction result.

In the embodiments of this disclosure, the i^{th} noisy feature vector is encoded by employing the encoding network constructed based on the streaming convolution structure, to obtain the i^{th} encoded result. Then, the i^{th} encoded result is analyzed by the recurrent neural network constructed based on the gated recurrent units, to obtain the i^{th} intermediate result carrying the time sequence information. Further, the i^{th} intermediate result is decoded by the decoding network constructed based on the streaming convolution structure, to obtain the i^{th} noise reduction result. In other words, in the embodiments of this disclosure, encoding and decoding are correspondingly performed by employing the encoding network and the decoding network constructed based on the streaming convolution structure, whereby the time domain continuity of the information can be maintained. In addition, the time sequence information may be obtained effectively by employing the recurrent neural network constructed based on the gated recurrent units for processing. Therefore, based on the foregoing structure, the noise reduction processing may be implemented accurately and comprehensively by referring to the information in the noisy feature vector.

As an alternative solution, the operation of encoding the i^{th} noisy feature vector by employing an encoding network constructed based on the streaming convolution structure, to obtain an i^{th} encoded result includes:
the i^{th} noisy feature vector is encoded by M encoding sub-networks having a connection relationship in the encoding network, to obtain the i^{th} encoded result, where each encoding sub-network includes a convolution layer, a normalization layer, and an activation layer, and when convolution processing is performed on each frame of noisy feature vectors in the convolution layer, refer to an adjacent preceding frame of noisy feature vectors, and M is a natural number greater than or equal to 2.

The operation of decoding the i^{th} intermediate result by employing a decoding network constructed based on the streaming convolution structure, to obtain the i^{th} noise reduction result includes:

the i^{th} intermediate result is decoded by employing M decoding sub-networks having a connection relationship in the decoding network to obtain the i^{th} noise reduction result, where each decoding sub-network includes a transposed convolution layer associated with the convolution layer, a normalization layer, and an activation layer, a hopping connection is set between a kth encoding sub-network and an (M−(k−1))^{th} decoding sub-network, and k is a natural number greater than or equal to 1 and less than or equal to M.

In addition, using an example in which the encoding network is an encoder module, the encoding sub-network may be, but is not limited to, configured to indicate EncConv2d modules included in the encoder module. Specifically, the EncConv2d module includes a convolution layer (i.e., two-dimensional convolution (Conv2d)), a normalization layer (i.e., normalization (BatchNorm)), and an activation layer (i.e., an activation function (PReLU)). A convolution kernel size of each layer of the EncConv2d is (5, 2), which represents that a field of view in the frequency domain is 5, and a field of view in the time domain is 2. To be specific, for the analysis and processing on each frame of signal features, refer to a preceding frame of signal, which may be considered as a streaming convolution structure, which ensures the network causality. A stride of the convolution may be, but is not limited to, set to (2, 1); and to be specific, a frequency domain stride of the convolution is 2, and a time domain stride is 1. In this way, a quantity of frequency domain features of the signal can be halved layer by layer, and the time domain feature dimension remains unchanged, which not only keeps time domain continuity of the information, but also can reduce the calculation amount.

Further, using an example in which the decoding network is a decoder module, the decoding sub-network may be, but is not limited to, configured to indicate the DecTConv2d modules included in the decoder module. The structure of the DecTConv2d is highly similar to that of the EncConv2d, and includes: a transposed convolution layer (i.e., a transposed convolution network (ConvTranspose2d)) corresponding to the convolution layer (i.e., two-dimensional convolution (Conv2d)) in the EncConv2d, a normalization layer (i.e., normalization (BatchNorm)), and an activation layer (i.e., an activation function (PReLU)). The number of layers of the DecTConv2d included in the decoder is the same as the number of layers of the EncConv2d included in the encoder. Parameters of each layer of the DecTConv2d are further the same as parameters of a corresponding layer of the EncConv2d. In addition, an output of each layer of the encoder may further be used as an influencing parameter of a corresponding layer in the decoder in a hopping connection manner, whereby layer-by-layer restoration of the signal feature dimension is achieved.

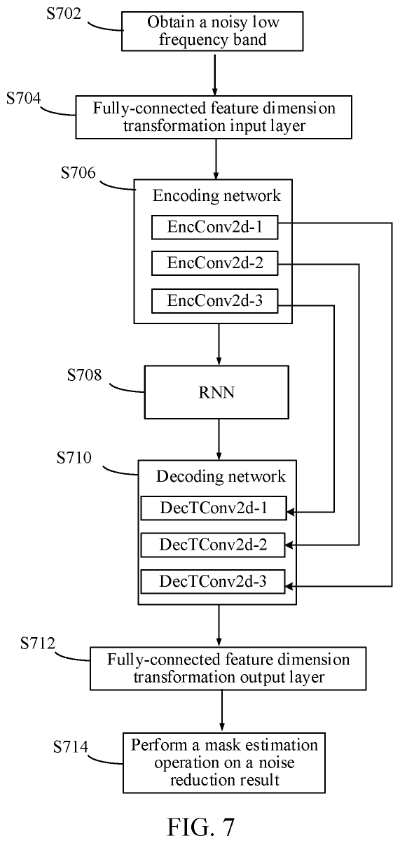

As an alternative implementation, an example in which the noisy frequency domain representation is divided into two noisy frequency bands, i.e., the noisy low frequency band [0, 8 kHz] and the noisy high frequency band (8 kHz, 24 kHz] is used. Using an example in which the current processed noisy frequency band is the noisy low frequency band, it is assumed that the encoding network in the low frequency noise reduction branch is an encoder module, and the encoder module includes three layers of EncConv2d modules. The decoding network in the low frequency noise reduction branch is a decoder module, and the decoder module includes three layers of DecTConv2d modules. The foregoing method is described by taking the following operations, as shown in FIG. 7, as an example:

Operation S702: Obtain a noisy low frequency band. Operation S704: Input the noisy low frequency band to a fully-connected feature dimension transformation input layer (i.e., the Dense input layer), and amplify the feature vector with an original feature length of 342 corresponding to the noisy low frequency band to a noisy feature vector with a feature length of 512 by employing the Dense input layer.

Operation S706: Input the noisy feature vector with the feature length of 512 into the encoding network, and transform the noisy feature vector with a frequency domain feature dimension of 512 into an encoded result with a frequency domain feature length of 256 by employing the EncConv2d-1 in the encoding network; transform the encoded result with the frequency domain feature length of 256 into an encoded result with a frequency domain feature length of 128 by employing the EncConv2d-2; and transform the encoded result with the frequency domain feature length of 128 into an encoded result with a frequency domain feature length of 64 by employing the EncConv2d-3.

Operation S708: Input the encoded result with the frequency domain feature length of 64 into the RNN, to obtain time sequence information in the encoded result by employing the RNN, whereby an intermediate result with the frequency domain feature length of 64 carrying the time sequence information is obtained.

Operation S710: Input the intermediate result with the frequency domain feature length of 64 carrying the time sequence information into the decoding network, transform the intermediate result with the frequency domain feature dimension of 64 into a noise reduction result with a frequency domain feature length of 128 by employing the DecTConv2d-1 in the decoding network module, and employ an output of the EncConv2d-3 to affect the calculation of the DecTConv2d-1; transform the noise reduction result with the frequency domain feature length of 128 into a noise reduction result with a frequency domain feature length of 256 by means of the DecTConv2d-2, and employ an output of the EncConv2d-2 to affect the calculation of the DecTConv2d-2; and transform the noise reduction result with the frequency domain feature length of 256 into a noise reduction result with a frequency domain feature length of 512 by means of the DecTConv2d-3, and employ an output of the EncConv2d-1 to affect the calculation of the DecTConv2d-3.

Operation S712 to operation S714: Input the noise reduction result with the frequency domain feature length of 512 to the fully-connected feature dimension transformation output layer (i.e., the Dense output layer), and perform dimension restoration processing on the noise reduction result with the frequency domain feature length of 512 by means of the Dense output layer, to obtain the noise reduction result with a feature length of 342; and perform a mask estimation operation on the noise reduction result with the feature length of 342, to obtain a mask estimation result corresponding to the noisy low frequency band.

Specifically, the mask estimation operation may include but is not limited to: a division operation is performed on the noise reduction result and the noisy high frequency band. To be specific, the mask estimation result corresponding to the noisy low frequency band equals the noise reduction result with the feature length of 342 divided by the noisy low frequency band. Alternatively, the mask estimation operation may alternatively be performed on the noise reduction result in another manner. This is not limited in the present embodiment.

As an alternative implementation, an example in which the noisy frequency domain representation is divided into two noisy frequency bands, i.e., the noisy low frequency band [0, 8 kHz] and the noisy high frequency band (8 kHz, 24 kHz] is used. Using an example in which the current processed noisy frequency band is the noisy high frequency band, it is assumed that the encoding network in the high frequency noise reduction branch is an encoder module, and the encoder module includes three layers of EncConv2d modules. The decoding network in the high frequency noise reduction branch is a decoder module, and the decoder module includes three layers of DecTConv2d modules. The foregoing method is described by taking the following operations as an example:

The noisy high frequency band is inputted to the Dense input layer, and the feature vector with an original feature length of 682 corresponding to the noisy high frequency band is compressed to a noisy feature vector with a feature length of 512 by means of the Dense input layer.

Then, the noisy feature vector with the feature length of 512 is inputted to the encoding network, and the noisy feature vector with a frequency domain feature dimension of 512 is transformed by the EncConv2d-4 in the encoding network into an encoded result with a frequency domain feature length of 256; the encoded result with the frequency domain feature length of 256 is transformed by the EncConv2d-5 into an encoded result with a frequency domain feature length of 128; and the encoded result with the frequency domain feature length of 128 is transformed by the EncConv2d-6 into an encoded result with a frequency domain feature length of 64.

Subsequently, the encoded result with the frequency domain feature length of 64 is inputted to the RNN, to obtain the time sequence information in the encoded result, whereby an intermediate result with the frequency domain feature length of 64 carrying the time sequence information is obtained.

Further, the intermediate result with the frequency domain feature length of 64 carrying the time sequence information is inputted into the decoding network, the intermediate result with the frequency domain feature dimension of 64 is transformed by the DecTConv2d-4 in the decoding network into a noise reduction result with a frequency domain feature length of 128, and an output of the EncConv2d-6 is employed to affect the calculation of the DecTConv2d-4; the noise reduction result with the frequency domain feature length of 128 is transformed by the DecTConv2d-5 into a noise reduction result with a frequency domain feature length of 256, and an output of the EncConv2d-5 is employed to affect the calculation of the DecTConv2d-5; and the noise reduction result with the frequency domain feature length of 256 is transformed by the DecTConv2d-6 into a noise reduction result with a frequency domain feature length of 512, and an output of the EncConv2d-4 is employed to affect the calculation of the DecTConv2d-6.

Subsequently, the noise reduction result with the frequency domain feature length of 512 is inputted to the Dense output layer, and dimension restoration processing is performed on the noise reduction result with the frequency domain feature length of 512 by means of the Dense output layer, to obtain a noise reduction result with a feature length of 682.

Further, a mask estimation operation is performed on the noise reduction result with the feature length of 682, to obtain a mask estimation result corresponding to the noisy high frequency band.

Specifically, the mask estimation operation may include but is not limited to: a division operation is performed on the noise reduction result and the noisy high frequency band. To be specific, the mask estimation result corresponding to the noisy high frequency band equals the noise reduction result with the feature length of 682 divided by the noisy high frequency band. Alternatively, the mask estimation operation may alternatively be performed on the noise reduction result in another manner. This is not limited in the present embodiment.

In the embodiments of this disclosure, the i^{th} noisy feature vector is encoded by the encoding network constructed based on the streaming convolution structure, to obtain the i^{th} encoded result. The i^{th} intermediate result is decoded by the decoding network constructed based on the streaming convolution structure, to obtain the i^{th} noise reduction result. In a manner of setting a hopping connection between the encoding sub-network and the decoding sub-network, the output result of the decoding sub-network is more accurate, which achieves a technical effect of improving the accuracy of the noise reduction processing on the audio signal.

As an alternative solution, the operation of decoding the i^{th} intermediate result by employing M decoding sub-networks having a connection relationship in the decoding network, to obtain the i^{th} noise reduction result further includes:
S1: Perform weighted summation processing on output results respectively corresponding to the M encoding sub-networks in the encoding network in the i^{th} noise reduction branch and M gated processing results associated with an (i−1)^{th} noise reduction branch when the i^{th} noise reduction branch is not the first noise reduction branch, to obtain M decoded reference results, where a j^{th} gated processing result is obtained by processing an output result of a j^{th} encoding sub-network in the (i−1)^{th} noise reduction branch by employing a j^{th} information transfer gated structure in the audio processing network, the convolution layer in each information transfer gated structure includes at least two convolution structures, and j is a natural number greater than or equal to 1 and less than or equal to M;
S2: Input each decoded reference result of the M decoded reference results respectively into the corresponding decoding sub-network of the M decoding sub-networks in the i^{th} noise reduction branch.

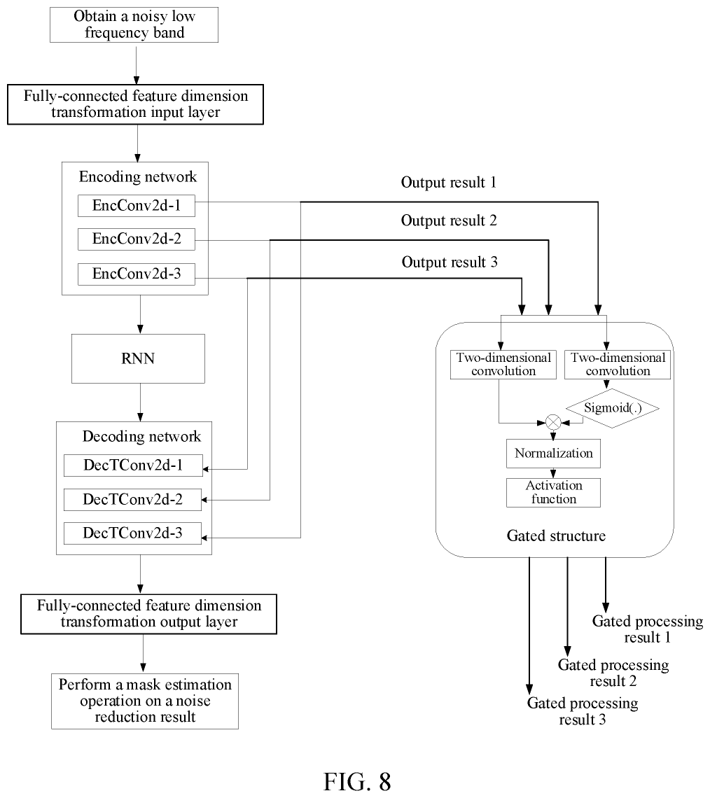

In addition, it is assumed that the noisy frequency domain representation is divided into two noisy frequency bands, which are respectively the noisy low frequency band and the noisy high frequency band. A gated structure is further set between the low frequency noise reduction branch configured to process the noisy low frequency band and the high frequency noise reduction branch configured to process the noisy high frequency band. The foregoing gated structure is configured to use a result obtained by modulating the output of the encoding network in the low frequency noise reduction branch as an instruction to act on the decoding network in the high frequency noise reduction branch together with the output of the encoding network in the high frequency noise reduction branch. Specifically, the foregoing gated structure may include but is not limited to, as shown in FIG. 8, two two-dimensional convolution layers (Conv2d), a normalization layer (BatchNorm), and a layer of activation function (PReLU). An input of the gated structure is an output result of each encoding sub-network (i.e., the EncConv2d module) included in the encoding network, and an output of the gated structure is a gated processing result corresponding to the output result of each encoding sub-network (i.e., the EncConv2d module) included in the encoding network. Taking FIG. 8 as an example, assuming that the encoding network includes three EncConv2d modules, i.e., EncConv2d-1, EncConv2d-2, and EncConv2d-3, the inputs of the gated structure are an output result 1 outputted by the EncConv2d-1, an output result 2 outputted by the EncConv2d-2, and an output result 3 outputted by the EncConv2d-3. The output of the gated structure is a gated processing result 1 obtained by calculating the output result 1 by means of the gated structure, a gated processing result 2 obtained by calculating the output result 2 by means of the gated structure, and a gated processing result 3 obtained by calculating the output result 3 by means of the gated structure.

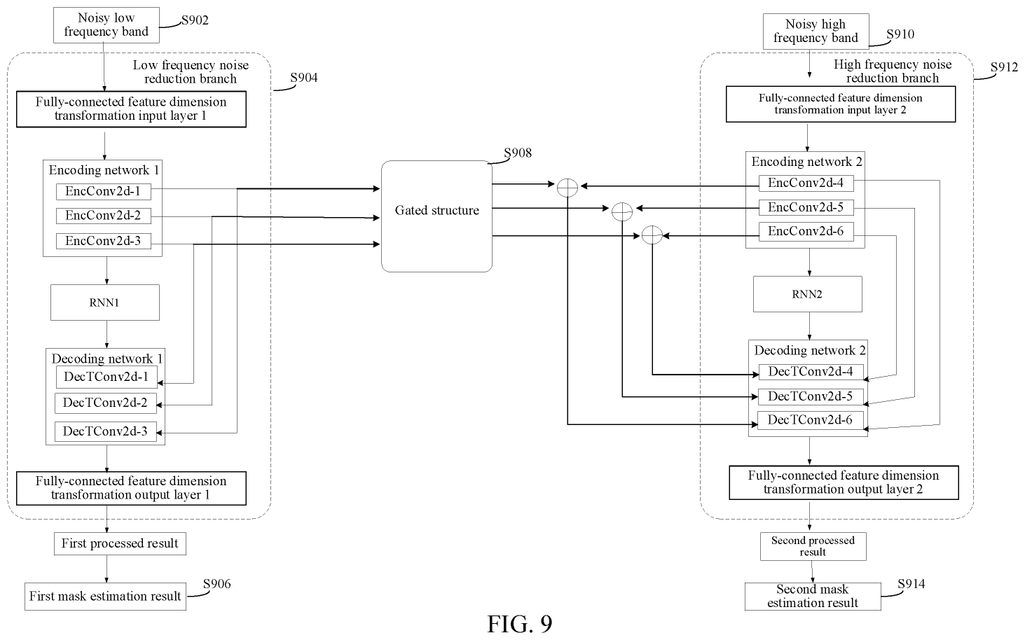

As an alternative implementation, an example in which the noisy frequency domain representation is divided into two noisy frequency bands, i.e., the noisy low frequency band [0, 8 kHz] and the noisy high frequency band (8 kHz, 24 kHz] is used. It is assumed that M is 3, the encoding network is an encoder module, and the decoding network is a decoder module. The foregoing method is described by taking the following operations, as shown in FIG. 9, as an example:

Operation S902: Obtain a noisy low frequency band. Operation S904: Process the noisy low frequency band by employing the low frequency noise reduction branch, to obtain a first processed result. Specifically, the noisy low frequency band is inputted to the fully-connected feature dimension transformation (i.e., Dense) input layer 1 of the low frequency noise reduction branch, and feature dimension transformation is performed on the noisy low frequency band, to obtain a first noisy feature vector with a target feature length. Then, the first noisy feature vector is inputted to the encoding network 1 of the low frequency noise reduction branch, and the first noisy feature vector is encoded by employing the EncConv2d-1, the EncConv2d-2, and the EncConv2d-3 in the encoding network 1. Then, the first encoded result outputted by the encoding network 1 is inputted to an RNN1 of the low frequency noise reduction branch. The first encoded result is processed by employing the RNN1, to obtain a first intermediate result carrying time sequence information. Subsequently, the first intermediate result is inputted to a decoding network 1 of the low frequency noise reduction branch. Then the first intermediate result is decoded sequentially by employing the DecTConv2d-1, the DecTConv2d-2, and the DecTConv2d-3 in the decoding network 1. Meanwhile, an output result of the EncConv2d-3 of the low frequency noise reduction branch is inputted to the DecTConv2d-1, an output result of the EncConv2d-2 of the low frequency noise reduction branch is inputted to the DecTConv2d-2, and an output result of the EncConv2d-1 of the low frequency noise reduction branch is inputted to the DecTConv2d-3. The calculation of the DecTConv2d-1 is affected by an output result of the EncConv2d-3 of the low frequency noise reduction branch, the calculation of the DecTConv2d-2 is affected by an output result of the EncConv2d-2 of the low frequency noise reduction branch, and the calculation of the DecTConv2d-3 is affected by an output result of the EncConv2d-1 of the low frequency noise reduction branch. Further, the first noise reduction result outputted by the decoding network 1 is obtained. Subsequently, the first noise reduction result is inputted to the fully-connected feature dimension transformation (i.e., Dense) output layer 1 of the low frequency noise reduction branch, to restore a feature dimension of the first noise reduction result to an original dimension corresponding to the noisy low frequency band, whereby the first processed result is obtained.

Operation S906: Perform a mask estimation operation on the first processed result, to obtain a first mask estimation result corresponding to the noisy low frequency band.

Operation S908: Calculate an output result of the encoding network 1 by employing the gated structure, to obtain a corresponding gated processing result. Specifically, the output result of the EncConv2d-1 is inputted into the gated structure, to obtain the gated processing result 1; the output result of the EncConv2d-2 is inputted into the gated structure, to obtain a gated processing result 2; and the output result of the EncConv2d-3 is inputted into the gated structure, to obtain the gated processing result 3.

Further, operation S910: Obtain a noisy high frequency band. Operation S912: Process the noisy high frequency band by means of the high frequency noise reduction branch, to obtain a second processed result. Specifically, the noisy high frequency band is inputted to a fully-connected feature dimension transformation (i.e., Dense) input layer 2 of the high frequency noise reduction branch. Feature dimension transformation is performed on the noisy high frequency band to obtain a second noisy feature vector with a target feature length. Then, the second noisy feature vector is inputted to an encoding network 2 of the high frequency noise reduction branch, and the second noisy feature vector is encoded sequentially by employing the EncConv2d-4, the EncConv2d-5, and the EncConv2d-6 in the encoding network 2. Then, the second encoded result outputted by the encoding network 2 is inputted to a RNN2 of the high frequency noise reduction branch. A second intermediate result carrying the time sequence information is obtained by employing the RNN2. Meanwhile, XOR processing is performed on the gated processing result 1 and the output result of the EncConv2d-4, to obtain a decoded reference result 1; the XOR processing is performed on the gated processing result 2 and the output result of the EncConv2d-5, to obtain a decoded reference result 2; and the XOR processing is performed on the gated processing result 3 and the output result of the EncConv2d-6, to obtain a decoded reference result 3. Subsequently, the second intermediate result is inputted into a decoding network 2 of the high frequency noise reduction branch, and then the second intermediate result is decoded sequentially by employing the DecTConv2d-4, the DecTConv2d-5, and the DecTConv2d-6 in the decoding network 2; and meanwhile, the decoded reference result 3 is inputted to the DecTConv2d-4, the decoded reference result 2 is inputted to the DecTConv2d-5, and the decoded reference result 1 is inputted to the DecTConv2d-6. The calculation of the DecTConv2d-4 is affected by the decoded reference result 3, the calculation of the DecTConv2d-5 is affected by the decoded reference result 2, and the calculation of the DecTConv2d-6 is affected by the decoded reference result 1. Further, a second noise reduction result outputted by the decoding network 2 is obtained. Subsequently, the second noise reduction result is inputted to the fully-connected feature dimension transformation (i.e., Dense) output layer 2 of the high frequency noise reduction branch, to restore the feature dimension of the second noise reduction result to an original dimension corresponding to the noisy high frequency band, to obtain the second processed result.

Operation S914: Perform a mask estimation operation on the second processed result, to obtain a second mask estimation result corresponding to a noisy high frequency band.

In the embodiments of this disclosure, the output results respectively corresponding to the M encoding sub-networks in the encoding network in the i^{th} noise reduction branch are processed by employing the M gated processing results associated with the (i−1)^{th} noise reduction branch. The accuracy of the output result of the decoding sub-network in the i^{th} noise reduction branch is improved. Further, a technical effect of improving the accuracy of the noise reduction processing result of the audio signal is achieved.

As an alternative solution, the operation of modulating the N branch mask estimation results by employing the noisy frequency domain representation, to obtain N speech frequency domain representations includes:
the N branch mask estimation results are concatenated to obtain a concatenation expression; and
modulation processing is performed on the concatenation expression by employing the noisy frequency domain representation, to obtain a full-band speech frequency domain representation.

Alternatively, in the present embodiment, the operation of performing modulation processing on the concatenation expression by employing the noisy frequency domain representation, to obtain a full-band speech frequency domain representation may include but is not limited to: a cross multiplication operation is performed on the noisy frequency domain representation and the concatenation expression, to obtain the full-band speech frequency domain representation.

As an alternative embodiment, it is assumed that the noisy frequency domain representation is divided into two noisy frequency bands, i.e., the noisy low frequency band and the noisy high frequency band. It is assumed that the mask estimation result corresponding to the noisy low frequency band is a first mask estimation result

$$( {m}_{k}^{l} ) ,$$

and the mask estimation result corresponding to the noisy high frequency band is a second mask estimation result

$$( {m}_{k}^{h} ) .$$

The operation of concatenating the N branch mask estimation results, to obtain a concatenated expression may include but is not limited to: the first mask estimation result

$$( {m}_{k}^{l} )$$

and the second mask estimation result

$$( {m}_{k}^{h} )$$

are concatenated, to obtain the concatenation expression (mₖ), namely,

$${m}_{k} = ( {m}_{k}^{l} , {m}_{k}^{h} ) .$$

Specifically, the manner of concatenating the first mask estimation result

$$( {m}_{k}^{1} )$$

and the second mask estimation result

$$( {m}_{k}^{h} )$$

may include but is not limited to:

$${m}_{k}^{h}$$

is concatenated to the end of

$${m}_{k}^{l} , or {m}_{k}^{l}$$

is concatenated to the end of

$${m}_{k}^{h} .$$

This is not limited in the present embodiment.

In the embodiments of this disclosure, the N branch mask estimation results are concatenated to obtain the concatenation expression. Then, modulation processing is performed on the concatenation expression by employing the noisy frequency domain representation to obtain the full-band speech frequency domain representation. In other words, in the embodiments of this disclosure, a plurality of noise reduction branches are employed to perform the noise reduction processing respectively on a plurality of noisy frequency domain bands corresponding to the audio signal. Then, the mask estimation results obtained respectively by means of the N branches are concatenated, calculated, and transformed, to obtain the full-band estimation result of the speech signal, whereby the accurate full-band speech signal free from noise interference is obtained. Consequently, the problem in the related art that the noise reduction processing result obtained by employing an audio signal processing model of a fixed sampling rate to perform the noise reduction processing on the audio signal is inaccurate can be avoided. Therefore, a technical effect for improving the accuracy of audio signal noise reduction processing is achieved.

As an alternative solution, the operation of performing time domain transformation on the N speech frequency domain representations, to obtain a speech signal in the audio signal includes:
time domain transformation is performed on the full-band speech frequency domain representation, to obtain the full-band estimation result of the speech signal.

Further, performing time domain transformation on the full-band speech frequency domain representation may be, but is not limited to, to perform inverse short-time discrete cosine transform (ISDCT) processing on the full-band speech frequency domain representation.

As an alternative implementation, it is assumed that the noisy frequency domain representation is Xₖ, and the noisy frequency domain representation Xₖ is divided into two noisy frequency bands, i.e., the noisy low frequency band and the noisy high frequency band. It is assumed that the mask estimation result corresponding to the noisy low frequency band is the first mask estimation result

$$( {m}_{k}^{l} ) ,$$

and the mask estimation result corresponding to the nosy high frequency band is the second mask estimation result

$$( {m}_{k}^{h} ) .$$

The foregoing method is described by taking the following operations as an example:

The first mask estimation result

$$( {m}_{k}^{l} )$$

and the second mask estimation result

$$( {m}_{k}^{h} )$$

are concatenated to obtain a concatenation expression (mₖ), namely,

$${m}_{k} = ( {m}_{k}^{l} , {m}_{k}^{h} ) .$$

Then, a cross multiplication operation is performed on the concatenation expression (mₖ) and the noisy frequency domain representation (Xₖ) of the audio signal to obtain a full-band frequency spectrum estimation (\tilde{S}), namely, \tilde{S}ₖ=mₖ×Xₖ.

Then, inverse short-time discrete cosine transform (ISDCT) processing is performed on \tilde{S}ₖ to obtain the full-band estimation result \tilde{s}ₙ of the speech signal (i.e., a noise-free full-band speech signal).

In the embodiments of this disclosure, the N branch mask estimation results are concatenated to obtain the concatenation expression. Then, modulation processing is performed on the concatenation expression by employing the noisy frequency domain representation to obtain the full-band speech frequency domain representation. In other words, in the embodiments of this disclosure, the plurality of noise reduction branches are employed to perform noise reduction processing respectively on the plurality of noisy frequency domain bands corresponding to the audio signal. Then, the mask estimation results obtained respectively by means of the N branches are concatenated, calculated, and transformed, to obtain the full-band estimation result of the speech signal, whereby the accurate full-band speech signal free from noise interference is obtained. Consequently, the problem in the related art that the noise reduction processing result obtained by employing an audio signal processing model of a fixed sampling rate to perform the noise reduction processing on the audio signal is inaccurate can be avoided. Therefore, a technical effect for improving the accuracy of audio signal noise reduction processing is achieved.

As an alternative solution, before the operation of concatenating the N branch mask estimation results to obtain a concatenation expression, the method further includes:
S1: Perform modulation processing on the noisy frequency domain representation of the i^{th} noisy frequency band by employing the i^{th} branch mask estimation result, to obtain an i^{th} speech frequency domain representation; and
S2: Perform time domain transformation on the i^{th} speech frequency domain representation, to obtain an i^{th} frequency band estimation result of the speech signal.

As an alternative implementation, it is assumed that the noisy frequency domain representation is Xₖ, and the noisy frequency domain representation (Xₖ) is divided into two noisy frequency bands, i.e., the noisy low frequency band

$$( {X}_{k}^{l} )$$

and the noisy high frequency band

$$( {X}_{k}^{h} ) .$$

It is assumed that the mask estimation result corresponding to the noisy low frequency band is a first mask estimation result

$$( {m}_{k}^{l} ) ,$$

and the mask estimation result corresponding to the nosy high frequency band is a second mask estimation result

$$( {m}_{k}^{h} ) .$$

The foregoing method is described by taking the following operations as an example:

For the noisy low frequency band, a cross multiplication operation is performed on the noisy low frequency band

$$( {X}_{k}^{l} )$$

and the first mask estimation result (mₖ^{l}) to obtain a spectrum estimation

$$( {\tilde{S}}_{k}^{l} )$$

corresponding to the noisy low frequency band, namely,

$${\tilde{S}}_{k}^{l} = {X}_{k}^{l} \times {m}_{k}^{l} .$$

Further, inverse short-time discrete cosine transform (ISDCT) processing is performed on the spectrum estimation

$$( {\tilde{S}}_{k}^{1} )$$

corresponding to the noisy low frequency band to obtain a low frequency band estimation result \tilde{s}ₙ^{l} (i.e., a noise-free wide-band speech signal).

For a noisy high frequency band, a cross multiplication operation is performed on the noisy high frequency band

$$( {X}_{k}^{h} )$$

and the second mask estimation result

$$( {m}_{k}^{h} )$$

to obtain a spectrum estimation

$$( {\tilde{S}}_{k}^{h} )$$

corresponding to the noisy high frequency band, namely,

$${\tilde{S}}_{k}^{h} = {X}_{k}^{h} \times {m}_{k}^{h} .$$

Further, the inverse short-time discrete cosine transform (ISDCT) processing is performed on the spectrum estimation

$$( {\tilde{S}}_{k}^{h} )$$

corresponding to the noisy high frequency band to obtain a high frequency band estimation result

$${\tilde{s}}_{n}^{h} .$$

In the embodiments of this disclosure, modulation processing is performed on the noisy frequency domain representation of the i^{th} noisy frequency band by employing the i^{th} branch mask estimation result corresponding to the i^{th} noisy frequency band, to obtain the i^{th} speech frequency domain representation. Then, time domain transformation is performed on the i^{th} speech frequency domain representation, to obtain the i^{th} frequency band estimation result of the speech signal. In this way, the modulation processing may be accurately performed on the noisy frequency domain representation of the corresponding noisy frequency band based on the corresponding branch mask estimation result, to obtain the speech signal free from noise interference corresponding to the noisy frequency band, and consequently, a denoising effect is improved.

As an alternative solution, before the operation of performing frequency domain transformation on the audio signal, to obtain a noisy frequency domain representation corresponding to the audio signal, the method further includes:
the audio signal is sampled according to a target sampling rate, to obtain sampled audio data; and
time domain framing processing is performed on the sampled audio data, to obtain a processed audio signal.

In addition, the target sampling rate may be preset according to actual needs. Specifically, the target sampling rate may be set to, but is not limited to, 48 kHz, 44.1 kHz, and the like. This is not limited in the present embodiment.

Further, the operation of performing time domain framing processing on the sampled audio data may include but is not limited to: framing and windowing modulation processing is performed on the audio data to prevent spectrum leakage. For example, the audio data may be, but not limited to, segmented into multiple frames of short signals with a fixed length, with each frame including 1024 sampling points (i.e., a frame length of 1024) and a frame shift of 512 (i.e., an overlap length of 512 between two adjacent frames). Further, each frame of signal in the audio data is modulated by using a Hamming window, to obtain a modulated audio signal, whereby spectrum leakage is prevented.

In addition, a windowing processing manner for windowing the audio data is not limited to the Hamming window, and may further employ other manners such as a rectangular window or a Hanning window. This is not limited in the present embodiment.

As an alternative embodiment, the foregoing method is described by taking the following operations as an example:

The audio signal is sampled according to a sampling rate of 48 kHz, to obtain the sampled audio data. Then, the framing and window modulation processing is performed on the sampled audio data, to obtain the processed audio signal.

In the embodiments of this disclosure, the audio signal is sampled according to the target sampling rate, to obtain the sampled audio data. Then, the time domain framing processing is performed on the sampled audio data, to obtain the processed audio signal. Subsequently, denoising processing is performed on the audio signal obtained after the time domain framing processing, which improves the accuracy of noise reduction processing on the audio signal.

As an alternative solution, before the operation of obtaining a to-be-processed audio signal, the method further includes:
a speech data set and a noise data set are obtained;
the speech data set and the noise data set are mixed to obtain a sample noisy audio signal; and
an initialized audio processing network is trained by employing the sample noisy audio signal until a loss function of the audio processing network reaches a convergence condition, where the loss function is configured for calculating a difference between a speech signal in the speech data set and a candidate reference speech signal recognized by the trained audio processing network from the sample noisy audio signal.

Alternatively, in the present embodiment, the speech data set may be, but is not limited to, a pure noise-free speech set. The noise data set may be, but is not limited to, a useless noise speech set.

As an alternative implementation, it is assumed that the speech data set is sₙ, and the noise data set is dₙ. The foregoing method is described by taking the following operations as an example:

the speech data set is obtained as sₙ, and the noise data set is obtained as dₙ. Then, the speech data set sₙ and the noise data set dₙ are mixed to obtain the sample noisy audio signal xₙ. Subsequently, xₙ is inputted to the initialized audio processing network to obtain an output result \tilde{s}ₙ (i.e., a noise-free speech data set), to train the initialized audio processing network, until the loss function of the audio processing network reaches a predetermined threshold, where an expression of the loss function may be but is not limited to:

$$L = L ( {s}_{n} , {\tilde{s}}_{n} ) \qquad ( 1 )$$

Where sₙ is the noise-free speech data set, and \tilde{s}ₙ is the output result of the audio processing network in a training process. In addition, the loss function may be, but is not limited to, any one of a mean square error loss function (MSE), a mean absolute error loss function (MAE), a scale invariant signal-to-noise ratio (SI-SNR), and the like. This is not limited in the present embodiment.

In the embodiments of this disclosure, the initialized audio processing network is trained in advance by means of rich sample information, to obtain the completely trained audio processing network. Consequently, the audio processing network is employed to perform the noise reduction processing on the audio signal. Further, a technical effect of improving the accuracy of noise reduction processing is achieved.

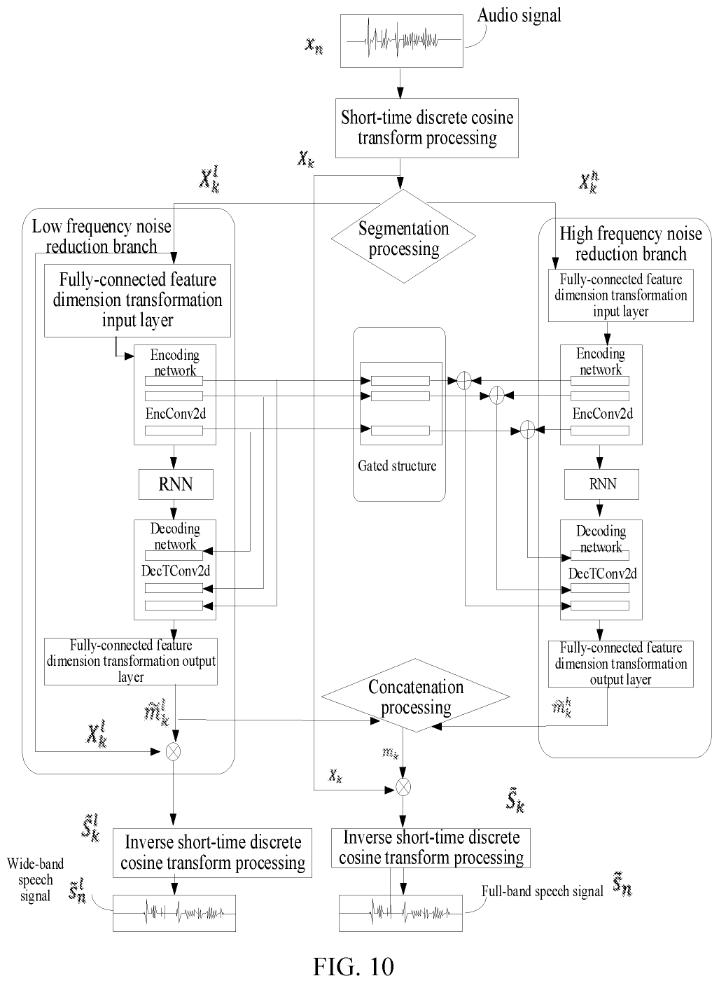

In an alternative embodiment, the audio noise reduction processing method is described by taking the following operations, as shown in FIG. 10, as an example:

a noise-containing audio signal xₙ is obtained, short-time discrete cosine transform processing is performed on the target audio signal xₙ to obtain a frequency domain feature Xₖ of the audio signal. Subsequently, the frequency domain feature Xₖ is segmented to obtain the noisy low frequency band

$${X}_{k}^{l}$$

and the noisy high frequency band

$${X}_{k}^{h} .$$

Then, the noisy low frequency band

$${X}_{k}^{l}$$

is inputted into the low frequency noise reduction branch and processed sequentially by means of a fully-connected feature dimension transformation input layer, an encoding network, an RNN, and a fully-connected feature dimension transformation output layer, to obtain a mask estimation result

$${\tilde{m}}_{k}^{l}$$

corresponding to the noisy low frequency band. Further, a cross multiplication operation is performed on

$${\tilde{m}}_{k}^{l} and {x}_{k}^{l}$$

to obtain an operation result, and a mask estimation operation is performed on the operation result to obtain a spectrum estimation

$${\tilde{S}}_{k}^{l}$$

corresponding to the noisy low frequency band. Further, inverse short-time discrete cosine transform processing is performed on

$${\tilde{S}}_{k}^{l} ,$$

to obtain a wide-band speech signal

$${\tilde{s}}_{n}^{l}$$

free from noise interference. The output result of the EncConv2d in the encoding network is employed to assist the calculation of the DecTConv2d in the decoding network.

The noisy high frequency band

$${X}_{k}^{h}$$

is inputted to the high frequency noise reduction branch and processed sequentially by means of the fully-connected feature dimension transformation input layer, the encoding network, the RNN, and the fully-connected feature dimension transformation output layer, to obtain a mask estimation result

$${\tilde{m}}_{k}^{h}$$

corresponding to the noisy high frequency band. Further, the mask estimation result

$${\tilde{m}}_{k}^{h}$$

and the mask estimation result

$${\tilde{m}}_{k}^{l}$$

are concatenated to obtain a concatenated mask estimation result mₖ. Cross multiplication operation processing is performed on the concatenated mask estimation results mₖ and Xₖ to obtain an operation result, and a mask estimation operation is performed on the operation result, to obtain a spectrum estimation \tilde{S}ₖ corresponding to the full-band speech signal. Inverse short-time discrete cosine transform (ISTFT) processing is performed on the operation result \tilde{S}ₖ, to obtain the full-band speech signal \tilde{s}ₙ free from the noise interference. The gated structure is employed to use instructions obtained after modulating the output of the EncConv2d in the encoding network in the low frequency noise reduction branch and the output of the EncConv2d in the encoding network in the high frequency noise reduction branch to assist an operation of the DecTConv2d in the decoding network in the high frequency noise reduction branch.

In the present embodiment, a plurality of noise reduction branches are employed to perform noise reduction processing respectively on a plurality of noisy frequency domain bands corresponding to the audio signal, whereby the speech signal free from the noise signal interference is obtained. Consequently, the problem in the related art that the noise reduction processing result obtained by employing an audio signal processing model of a fixed sampling rate to perform the noise reduction processing on the audio signal is inaccurate can be avoided. Therefore, a technical effect for improving the accuracy of audio signal noise reduction processing is achieved.

As another alternative embodiment, a system frame used in the foregoing audio noise reduction processing method is described by taking the following operations as an example:
1) a pretreatment and feature extraction module: re-sampling processing is performed on the noisy speech signal xₙ to re-sample audio data of all sampling rate types to 48 kHz. Subsequently, after the re-sampling operation, time domain framing and windowing processing is performed on a long audio signal, the original audio signal is segmented into a plurality of frames of short signals with a fixed length according to a single frame length of 1024 and a frame shift of 512 (an overlap length of 512), and each frame of signal is modulated by employing a Hamming window to prevent spectrum leakage. Discrete cosine transform operation is performed on the modulated signal after the framing and windowing operation, and a frequency domain feature is extracted to obtain a frequency domain representation Xₖ of the noisy speech signal xₙ. A combination of the framing and windowing processing and the cosine transform operation for the audio signal may further be referred to as short-time discrete cosine transform. After obtaining frequency domain representation Xₖ of the noisy speech by means of the short-time discrete cosine transform, the frequency domain representation is divided, where frequency points less than 8 kHz constitute

$${X}_{k}^{l} ,$$

which may be considered as a cosine spectrum of a wide-band signal, and the frequency points greater than 8 kHz constitute

$${X}_{k}^{h} ,$$

with a bandwidth twice of

$${X}_{k}^{l} .$$

2) Neural network forward inference module: a two-path encoder-decoder interaction structure is used to perform modeling analysis respectively on the low frequency band [0, 8 kHz] and the high frequency band [8 kHz, 24 kHz] of an audio. A network model is mainly divided into three parts, which are respectively a low frequency branch, a high frequency branch, and a gated structure transferring low frequency information to the high frequency branch. The structure of the low frequency branch is symmetric to that of the high frequency branch, and both the low frequency branch and the high frequency branch include four parts, which are respectively a fully-connected feature dimension transformation layer Dense, an encoder module, a recurrent neural network module (RNN), and a decoder module. The function of the Dense input layer is to perform dimension transformation on low-frequency and high-frequency features entering the two branches. A length of the low-frequency feature is changed from 342 to 512, and a length of the high-frequency feature is compressed from 682 to 512. In this way, data feature lengths of the high frequency branch and the low frequency branch may be unified, to facilitate interaction. The Dense output layer performs inverse transformation on the feature dimension. The encoder part is mainly formed by staking EncConv2d modules layer by layer with two-dimensional convolution (Conv2d) as a core, supplemented by operations such as batch normalization (BatchNorm) and an activation function PRELU. A convolution kernel size of each layer of the EncConv2d is (5, 2), which represents that a field of view in the frequency domain is 5, and a field of view in the time domain is 2. For the analysis and processing on each frame of signal features, refer to a preceding frame of signal. The encoder part may be considered as a streaming convolution structure, which ensures the network causality. A stride of the convolution is (2, 1), whereby a quantity of frequency domain features of the signal can be halved layer by layer, and the time domain feature dimension remains unchanged, which not only keeps the time domain continuity of information, but also can reduce the calculation amount. The decoder part is mainly formed by stacking DecTConv2d modules, and a structure of the DecTConv2d is highly similar to that of the EncConv2d, but a convolution structure therein is replaced with a transposed convolution network (ConvTranspose2d). A quantity of layers of the decoder is the same as the encoder, and parameters of each layer of the DecTConv2d are the same as the corresponding EncConv2d. An output of the encoder is used as an input of the decoder in a hopping connection manner, achieving layer-by-layer restoration of the signal feature dimension. A recurrent neural network module RNN formed by stacking gated recurrent units (GRU) is disposed between the encoder module and the decoder module, and is configured to analyze and extract time sequence information. A main function of an information transfer module is to enable a modulated output of a low frequency branch encoder as instructions to act on a high frequency branch decoder together with an output of a high frequency branch encoder. The module adopts the gated structure to extract the information. Final output targets of the two branches are short-time discrete cosine transform mask estimations of the signal, and an estimated mask value of the low frequency branch is

$${\tilde{m}}_{k}^{l} ,$$

and an estimated mask value of the high frequency branch is

$${\tilde{m}}_{k}^{h} .$$

3) Post-processing speech generation module: after the short-time discrete cosine transform masks of the low frequency and high frequency signal components are obtained, an original noisy speech short-time cosine spectrum is modulated, to respectively obtain low frequency and high frequency short-time cosine spectrum estimations. An expression is as follows:

$${\tilde{S}}_{k}^{l} = {X}_{k}^{l} \cdot {\tilde{m}}_{k}^{l} \qquad ( 2 )$$

$${\tilde{S}}_{k} = ( {m}_{k}^{l} , {m}_{k}^{h} ) \cdot {X}_{k} \qquad ( 3 )$$

An estimated value

$${\tilde{s}}_{n}^{l}$$

of a wide-band pure speech signal may be obtained by performing inverse short-time discrete cosine transform on the low frequency cosine spectrum. However, iSDCT is performed on a combination of the low frequency and high frequency cosine spectra to obtain the estimated value \tilde{s}ₙ of the full-band pure speech signal.

In addition, in the present embodiment, a design mode of a frequency-band-separated speech enhancement and noise reduction model is provided, which simultaneously solves the noise suppression problem of the wide-band signal and the full-band signal without introducing additional calculation amount. A frequency-band-separated noise reduction system based on an encoder-decoder two-way interaction structure is provided. Noise components in each frequency band are effectively suppressed by performing modeling analysis respectively on the low frequency band and the high frequency band of the noisy audio. The conventional speech enhancement and noise reduction solution performs modeling analysis only for one sampling rate signal. The present embodiment may employ the two-way structure to process the wide-band signal (16 kHz) and the full-band signal (48 kHz), enabling one system to adapt to two different application scenarios.

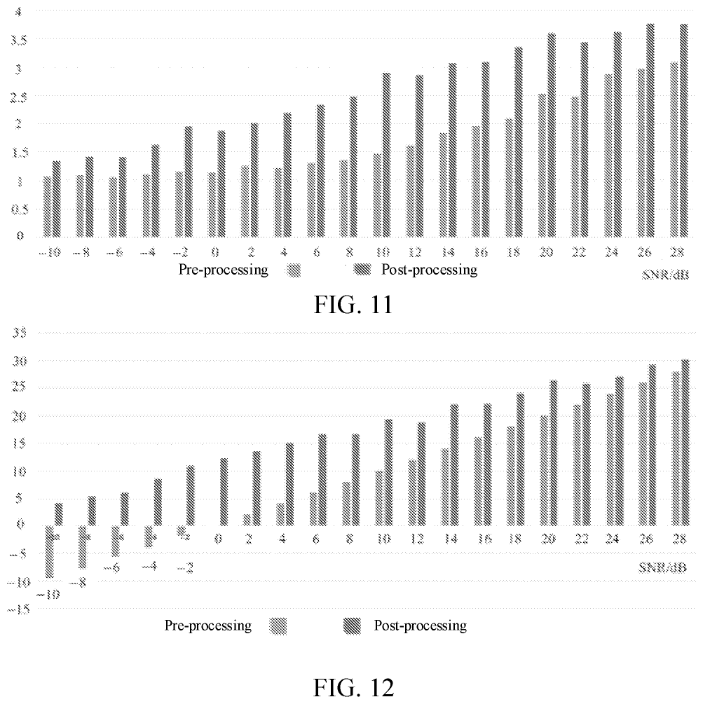

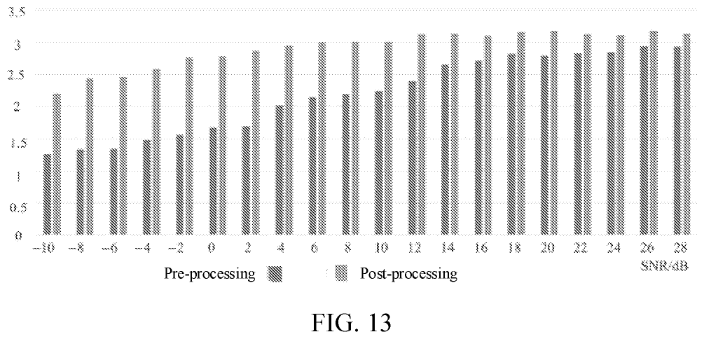

Further, a test result in the present embodiment is obtained by using 1000 sets of test data with a signal-to-noise ratio range of [−10, 30] dB and a stride of 2 dB. A speech perceptual quality parameter PESQ, a scale-invariant signal-to-noise ratio parameter (SI-SNR), and a simulated subjective audio quality perceptual parameter (DNSMOS) are selected as performance evaluation indexes to determine the test result. Specifically, FIG. 11 shows a test result of a PESQ index, FIG. 12 shows a test result of an SI-SNR index, and FIG. 13 shows a test result of an MOS_OVL index.

In addition, for ease of description, the foregoing method embodiments are described as a series of action combinations. However, a person skilled in the art knows that this disclosure is not limited to the described order of the actions because some operations may be performed in another order or performed at the same time according to this disclosure. In addition, a person skilled in the art is further to learn that the embodiments described in this specification are all exemplary embodiments, and the involved actions and modules are not necessarily required in this disclosure.

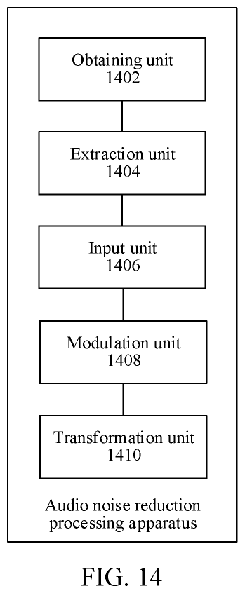

According to another aspect of the embodiments of this disclosure, an audio noise reduction processing apparatus for implementing the foregoing audio noise reduction processing method is further provided. As shown in FIG. 14, the apparatus includes:
an obtaining unit 1402, configured to obtain a to-be-processed speech signal, where the speech signal includes a to-be-recognized speech signal interfered with by a noise signal;
an extraction unit 1404, configured to perform frequency domain transformation on the speech signal, to obtain a noisy frequency domain representation corresponding to the speech signal;
an input unit 1406, configured to divide the noisy frequency domain representation into N noisy frequency bands, and input the N noisy frequency bands respectively into N noise reduction branches in an audio processing network, to obtain N branch mask estimation results, where an i^{th} noise reduction branch in the audio processing network is configured to process an i^{th} noisy frequency band among the N noisy frequency bands, to obtain an i^{th} branch mask estimation result corresponding to the i^{th} noisy frequency band, the N noise reduction branches have a same signal processing structure, i is a natural number greater than or equal to 1 and less than or equal to N, and N is a natural number greater than 1;
a modulation unit 1408, configured to modulate the N branch mask estimation results by employing the noisy frequency domain representation, to obtain N speech frequency domain representations; and
a transformation unit 1410, configured to perform time domain transformation on the N speech frequency domain representations, to obtain a speech signal free from noise signal interference in the speech signal.

Alternatively, the input unit includes:
an execution module, configured to perform the following operations on the i^{th} noisy frequency band in the i^{th} noise reduction branch: perform feature dimension transformation on the i^{th} noisy frequency band, to obtain an i^{th} noisy feature vector having a target feature length; perform noise reduction processing on the i^{th} noisy feature vector, to obtain an i^{th} noise reduction result; perform inverse feature dimension transformation on the i^{th} noise reduction result, to obtain an i^{th} branch processing result with a feature length the same as that of the i^{th} noisy frequency band; and perform a mask estimation operation on the i^{th} branch processing result, to obtain the i^{th} branch mask estimation result corresponding to the i^{th} noisy frequency band.

Alternatively, the execution module is further configured to encode the i^{th} noisy feature vector by employing an encoding network constructed based on a streaming convolution structure, to obtain an i^{th} encoded result; analyze the i^{th} encoded result by employing the recurrent neural network constructed based on gated recurrent units, to obtain an i^{th} intermediate result carrying time sequence information; and decode the i^{th} intermediate result by employing a decoding network constructed based on the streaming convolution structure, to obtain an i^{th} noise reduction result, where a sub-network in the decoding network is obtained by adjusting a sub-network in the encoding network.

Alternatively, the execution module is further configured to encode the i^{th} noisy feature vector by employing M encoding sub-networks having a connection relationship in the encoding network, to obtain the i^{th} encoded result, where each encoding sub-network includes a convolution layer, a normalization layer, and an activation layer, and when convolution processing is performed on each frame of noisy feature vectors in the convolution layer, refer to an adjacent preceding frame of noisy feature vectors, and M is a natural number greater than or equal to 2; decode the i^{th} intermediate result by employing M decoding sub-networks having a connection relationship in the decoding network to obtain the i^{th} noise reduction result, where each decoding sub-network includes a transposed convolution layer associated with the convolution layer, a normalization layer, and an activation layer, a hopping connection is set between a kth encoding sub-network and an (M−(k−1))^{th} decoding sub-network, and k is a natural number greater than or equal to 1 and less than or equal to M.

Alternatively, the execution module is further configured to perform weighted summation processing respectively on output results corresponding to M encoding sub-networks in the encoding network in the i^{th} noise reduction branch and M gated processing results associated with an (i−1)^{th} noise reduction branch when the i^{th} noise reduction branch is not the first noise reduction branch, to obtain M decoded reference results, where a j^{th} gated processing result is obtained by processing an output result of a j^{th} encoding sub-network in the (i−1)^{th} noise reduction branch by using a j^{th} information transfer gated structure in the audio processing network, the convolution layer in each information transfer gated structure includes at least two convolution structures, and j is a natural number greater than or equal to 1 and less than or equal to M; and input each decoded reference result of the M decoded reference results respectively into the corresponding decoding sub-network of the M decoding sub-networks in the i^{th} noise reduction branch.

Alternatively, the foregoing modulation unit includes:
a concatenating module, configured to concatenate the N branch mask estimation results to obtain a concatenation expression; and
a modulation module, configured to perform modulation processing on the concatenation expression by employing the noisy frequency domain representation, to obtain a full-band speech frequency domain representation.

Alternatively, the transformation unit is further configured to perform time domain conversion processing on the full-band speech frequency domain representation, to obtain a full-band estimation result of the speech signal.

Alternatively, the modulation unit includes:
a first modulation module, configured to perform modulation processing on the noisy frequency domain representation of the i^{th} noisy frequency band by employing the i^{th} branch mask estimation result, to obtain an i^{th} speech frequency domain representation; and
a transformation module, configured to perform time domain transformation on the i^{th} speech frequency domain representation, to obtain an i^{th} frequency band estimation result of the speech signal.

Alternatively, the apparatus further includes:
a sampling unit, configured to sample the speech signal according to a target sampling rate, to obtain sampled audio data; and
a processing unit, configured to perform time domain framing processing on the sampled audio data, to obtain a processed audio signal.

Alternatively, the apparatus further includes:
a first obtaining unit, configured to obtain a speech data set and a noise data set;
a mixing unit, configured to mix the speech data set and the noise data set to obtain a sample noisy audio signal; and
a training unit, configured to train an initialized audio processing network by employing the sample noisy audio signal until a loss function of the audio processing network reaches a convergence condition, where the loss function is configured for calculating a difference between a speech signal in the speech data set and a candidate reference speech signal recognized by the trained audio processing network from the sample noisy audio signal.

For specific embodiments, reference is made to the examples shown in the foregoing audio noise reduction processing method, which is not described again in the present embodiment.

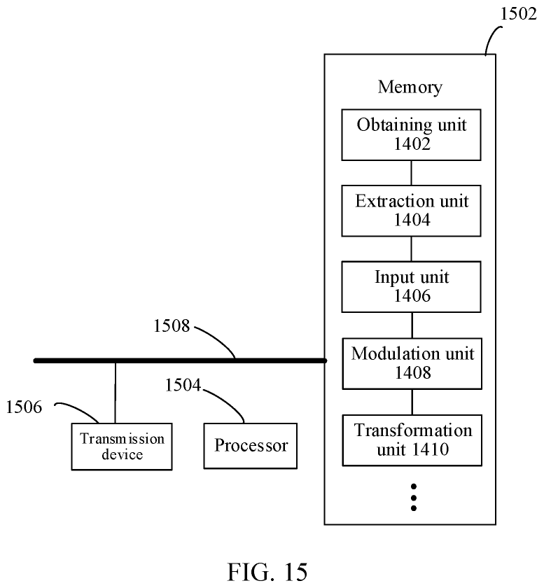

According to another aspect of the embodiments of this disclosure, an electronic device configured to implement the foregoing audio noise reduction processing method is further provided. In the present embodiment, an example in which the electronic device is a terminal is used for illustrative description. As shown in FIG. 15, the electronic device includes a memory 1502 and a processor 1504. The memory 1502 has a computer program stored therein, and the processor 1504 is configured to perform operations in any of the foregoing method embodiments by means of the computer program.

Alternatively, in the present embodiment, the electronic device may be located in at least one network device of a plurality of network devices in a computer network.

Alternatively, in the present embodiment, the processor may be configured to implement the audio noise reduction processing method provided by the embodiments of this disclosure by means of the computer program.

Alternatively, a person of ordinary skill in the art may understand that, the structure shown in FIG. 15 is only an example. The electronic device may be a terminal device such as a smartphone (such as an Android mobile phone, or an iOS mobile phone)), a tablet computer, a palmtop computer, a mobile Internet device (MID), or a PAD. The structure of the foregoing electronic device is not limited in FIG. 15. For example, the electronic device may further include more or fewer components (for example, a network interface) than those shown in FIG. 15, or has a configuration different from that shown in FIG. 15.

The memory 1502 may be configured to store a software program and a module, such as program instructions/modules corresponding to the audio noise reduction processing method and apparatus in the embodiments of this disclosure. The processor 1504 performs various functional applications and data processing by running the software program and modules stored in the memory 1502, namely, implements the foregoing audio noise reduction processing method. The memory 1502 may include a high-speed random memory, and may further include a non-volatile memory, such as one or more magnetic storage apparatuses, a flash memory, or another nonvolatile solid-state memory. In some embodiments, the memory 1502 may further include memories remotely disposed relative to the processor 1504, and the remote memories may be connected to a terminal through a network. Examples of the network include, but are not limited to, the Internet, an Intranet, a local area network, a mobile communication network, and a combination thereof. The memory 1502 may be specifically configured to, but is not limited to, store information such as a target audio signal. As an example, as shown in FIG. 15, the foregoing memory 1502 may include, but is not limited to, the obtaining unit 1402, the extraction unit 1404, the input unit 1406, the modulation unit 1408, and the transformation unit 1410 in the audio noise reduction processing apparatus. In addition, the memory may further include, but is not limited to, other modules and units in the foregoing audio noise reduction processing apparatus. Details are not described again in this example.

Alternatively, a transmission apparatus 1506 is configured to receive or transmit data via a network. Specific examples of the network include a wired network and a wireless network. In an example, the transmission device 1506 includes a network interface controller (NIC). The NIC may be connected to another network device and a router by using a network cable, to communicate with the Internet or a local area network. In an example, the transmission device 1506 is a radio frequency (RF) module, which communicates with the Internet in a wireless manner.

In addition, the electronic device further includes: a connection bus 1508, configured to connect various module components in the electronic device.

In some other embodiments, the foregoing terminal device or server may be a node in a distributed system. The distributed system may be a blockchain system, and the blockchain system may be a distributed system formed by connecting a plurality of nodes through network communication. A peer to peer network may be formed between the nodes. A computing device in any form, for example, an electronic device such as a server or a terminal, may become a node in the blockchain system by joining in with the peer to peer network.

According to one aspect of this disclosure, a computer program product is provided. The computer program product includes a computer program or instructions. The computer program or instructions include a program code configured for performing the foregoing method. In such an embodiment, the computer program may be downloaded and installed from a network through a communication part, and/or installed from a removable medium. When executed by a central processing unit, the computer program executes functions provided in embodiments of this disclosure.

According to one aspect of this disclosure, a computer-readable storage medium is provided. A processor of a computer device reads computer instructions from the computer-readable storage medium. The processor executes the computer instructions, to enable the computer device to implement the audio noise reduction processing method.

Alternatively, in the present embodiment, a person of ordinary skill in the art may understand that, all or some operations in the methods of the foregoing embodiments may be performed by a program instructing hardware of the terminal device. The program may be stored in a computer-readable storage medium. The storage medium may include: a flash drive, a read-only memory (ROM), a random access memory (RAM), a magnetic disk, an optical disc, and the like.

When the integrated unit in the foregoing embodiments is implemented in a form of a software functional unit and sold or used as an independent product, the integrated unit may be stored in the foregoing computer-readable storage medium. Based on such an understanding, the technical solutions of this disclosure essentially, or a part contributing to the related art, or all or a part of the technical solution may be implemented in a form of a software product. The computer software product is stored in a storage medium and includes several instructions for instructing one or more computer devices (which may be a personal computer, a server, a network device or the like) to perform all or some of operations of the methods in the embodiments of this disclosure.

In the foregoing embodiments of this disclosure, the descriptions of the embodiments have respective focuses. For a part that is not described in detail in an embodiment, refer to related descriptions in other embodiments.

In the several embodiments provided in this disclosure, the disclosed client may be implemented in another manner. The apparatus embodiments described above are merely exemplary. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of this disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are merely exemplary implementations of this disclosure. A person of ordinary skill in the art may further make several improvements and modifications without departing from the principle of this disclosure, and the improvements and modifications fall within the protection scope of this disclosure.

What is claimed is:

1. An audio noise reduction processing method, performed by an electronic device, and comprising:
obtaining an audio signal, the audio signal comprising a to-be-recognized speech signal interfered with by a noise signal;
performing frequency domain transformation on the audio signal to obtain a noisy frequency domain representation corresponding to the audio signal;
dividing the noisy frequency domain representation into N noisy frequency bands;
inputting the N noisy frequency bands respectively into N noise reduction branches in an audio processing network, to obtain N branch mask estimation results, an i^{th} noise reduction branch in the audio processing network being configured to process an i^{th} noisy frequency band among the N noisy frequency bands, to obtain an i^{th} branch mask estimation result corresponding to the i^{th} noisy frequency band, the N noise reduction branches having a same signal processing structure, wherein i is a natural number greater than or equal to 1 and less than or equal to N, and N is a natural number greater than 1;
modulating the N branch mask estimation results by employing the noisy frequency domain representation, to obtain N speech frequency domain representations; and
performing time domain transformation on the N speech frequency domain representations, to obtain a speech signal free from noise signal interference in the audio signal.

2. The audio noise reduction processing method according to claim 1, wherein inputting the N noisy frequency bands respectively into the N noise reduction branches in the audio processing network, to obtain the N branch mask estimation results comprises:
performing, on the i^{th} noisy frequency band in the i^{th} noise reduction branch:
feature dimension transformation on the i^{th} noisy frequency band, to obtain an i^{th} noisy feature vector with a target feature length;
noise reduction processing on the i^{th} noisy feature vector, to obtain an i^{th} noise reduction result;
inverse feature dimension transformation on the i^{th} noise reduction result, to obtain an i^{th} branch processing result with a feature length matching that of the i^{th} noisy frequency band; and
a mask estimation operation on the i^{th} branch processing result, to obtain the i^{th} branch mask estimation result corresponding to the i^{th} noisy frequency band.

3. The audio noise reduction processing method according to claim 2, noise reduction processing on the i^{th} noisy feature vector to obtain the i^{th} noise reduction result comprises:
encoding the i^{th} noisy feature vector by employing an encoding network constructed based on a streaming convolution structure, to obtain an i^{th} encoded result;
analyzing the i^{th} encoded result by employing a recurrent neural network constructed based on gated recurrent units, to obtain an i^{th} intermediate result carrying time sequence information; and
decoding the i^{th} intermediate result by employing a decoding network constructed based on the streaming convolution structure, to obtain the i^{th} noise reduction result, wherein a sub-network in the decoding network is obtained by adjusting a sub-network in the encoding network.

4. The audio noise reduction processing method according to claim 3, wherein:
encoding the i^{th} noisy feature vector by employing the encoding network constructed based on the streaming convolution structure, to obtain the i^{th} encoded result comprises:
encoding the i^{th} noisy feature vector by employing M encoding sub-networks having a connection relationship in the encoding network, to obtain the i^{th} encoded result, wherein each encoding sub-network comprises a convolution layer, a normalization layer, and an activation layer, and when convolution processing is performed on each frame of noisy feature vectors in the convolution layer, reference is made to an adjacent preceding frame of noisy feature vectors, and M is a natural number greater than or equal to 2; and
decoding the i^{th} intermediate result by employing the decoding network constructed based on the streaming convolution structure, to obtain the i^{th} noise reduction result comprises:
decoding the i^{th} intermediate result by employing M decoding sub-networks having a connection relationship in the decoding network to obtain the i^{th} noise reduction result, wherein each decoding sub-network comprises a transposed convolution layer associated with the convolution layer, a normalization layer, and an activation layer, wherein a hopping connection is set between a kth encoding sub-network and a (M−(k−1))^{th} decoding sub-network, and k is a natural number greater than or equal to 1 and less than or equal to M.

5. The audio noise reduction processing method according to claim 4, during decoding the i^{th} intermediate result by employing the M decoding sub-networks having the connection relationship in the decoding network to obtain the i^{th} noise reduction result, further comprising:
performing weighted summation processing respectively on output results respectively corresponding to the M encoding sub-networks in the encoding network in the i^{th} noise reduction branch and M gated processing results associated with an (i−1)^{th} noise reduction branch when the i^{th} noise reduction branch is not a first noise reduction branch, to obtain M decoded reference results, wherein a j^{th} gated processing result is obtained by processing an output result of a j^{th} encoding sub-network in the (i−1)^{th} noise reduction branch by using a j^{th} information transfer gated structure in the audio processing network, the convolution layer in each information transfer gated structure comprises at least two convolution structures, and j is a natural number greater than or equal to 1 and less than or equal to M; and
inputting each decoded reference result of the M decoded reference results respectively into a corresponding decoding sub-network of the M decoding sub-networks in the i^{th} noise reduction branch.

6. The audio noise reduction processing method according to claim 1, wherein modulating the N branch mask estimation results by employing the noisy frequency domain representation, to obtain the N speech frequency domain representations comprises:
concatenating the N branch mask estimation results, to obtain a concatenation expression; and
performing modulation processing on the concatenation expression by employing the noisy frequency domain representation, to obtain a full-band speech frequency domain representation.

7. The audio noise reduction processing method according to claim 6, wherein performing the time domain transformation on the N speech frequency domain representations, to obtain the speech signal in the audio signal comprises:
performing time domain transformation on the full-band speech frequency domain representation, to obtain a full-band estimation result of the speech signal.

8. The audio noise reduction processing method according to claim 6, before concatenating the N branch mask estimation results, to obtain the concatenation expression, further comprising:
performing modulation processing on the noisy frequency domain representation of the i^{th} noisy frequency band by employing the i^{th} branch mask estimation result, to obtain an i^{th} speech frequency domain representation; and
performing time domain transformation on the i^{th} speech frequency domain representation, to obtain an i^{th} frequency band estimation result of the speech signal.

9. The audio noise reduction processing method according to claim 1, before performing the frequency domain transformation on the audio signal, to obtain the noisy frequency domain representation corresponding to the audio signal, further comprising:
sampling the audio signal according to a target sampling rate, to obtain sampled audio data; and
performing time domain framing processing on the sampled audio data, to obtain a processed audio signal.

10. The audio noise reduction processing method according to claim 1, before obtaining the audio signal, further comprising:
obtaining a speech data set and a noise data set;
mixing the speech data set and the noise data set, to obtain a sample noisy audio signal; and
training an initial audio processing network by employing the sample noisy audio signal until a loss function of the audio processing network satisfies a convergence condition, wherein the loss function is configured for calculating a difference between the speech signal in the speech data set and a candidate reference speech signal recognized from the sample noisy audio signal.

11. An audio noise reduction processing apparatus, comprising:
a memory capable of storing computer-readable instructions; and
at least one processor configured to read the computer-readable instructions, wherein, the processor, when executing the computer-readable instructions is configured to
obtain an audio signal, the audio signal comprising a to-be-recognized speech signal interfered with by a noise signal;
perform frequency domain transformation on the audio signal, to obtain a noisy frequency domain representation corresponding to the audio signal;
divide the noisy frequency domain representation into N noisy frequency bands;
input the N noisy frequency bands respectively into N noise reduction branches in an audio processing network, to obtain N branch mask estimation results, an i^{th} noise reduction branch in the audio processing network being configured to process an i^{th} noisy frequency band among the N noisy frequency bands, to obtain an i^{th} branch mask estimation result corresponding to the i^{th} noisy frequency band, the N noise reduction branches having a same signal processing structure, i being a natural number greater than or equal to 1 and less than or equal to N, and N being a natural number greater than 1;
modulate the N branch mask estimation results by employing the noisy frequency domain representation, to obtain N speech frequency domain representations; and
perform time domain transformation on the N speech frequency domain representations, to obtain a speech signal free from noise signal interference in the audio signal.

12. The audio noise reduction processing apparatus according to claim 11, wherein input the N noisy frequency bands respectively into the N noise reduction branches in the audio processing network, to obtain the N branch mask estimation results, comprises:
perform, on the i^{th} noisy frequency band in the i^{th} noise reduction branch:
feature dimension transformation on the i^{th} noisy frequency band, to obtain an i^{th} noisy feature vector with a target feature length;
noise reduction processing on the i^{th} noisy feature vector, to obtain an i^{th} noise reduction result;
inverse feature dimension transformation on the i^{th} noise reduction result, to obtain an i^{th} branch processing result with a feature length matching that of the i^{th} noisy frequency band; and
a mask estimation operation on the i^{th} branch processing result, to obtain the i^{th} branch mask estimation result corresponding to the i^{th} noisy frequency band.

13. The audio noise reduction processing apparatus according to claim 12, wherein noise reduction processing on the i^{th} noisy feature vector to obtain the i^{th} noise reduction result comprises:
encoding the i^{th} noisy feature vector by employing an encoding network constructed based on a streaming convolution structure, to obtain an i^{th} encoded result;
analyzing the i^{th} encoded result by employing a recurrent neural network constructed based on gated recurrent units, to obtain an i^{th} intermediate result carrying time sequence information; and
decoding the i^{th} intermediate result by employing a decoding network constructed based on the streaming convolution structure, to obtain the i^{th} noise reduction result, wherein a sub-network in the decoding network is obtained by adjusting a sub-network in the encoding network.

14. The audio noise reduction processing apparatus according to claim 13, wherein:
encode the i^{th} noisy feature vector by employing the encoding network constructed based on the streaming convolution structure, to obtain the i^{th} encoded result comprises:
encode the i^{th} noisy feature vector by employing M encoding sub-networks having a connection relationship in the encoding network, to obtain the i^{th} encoded result, wherein each encoding sub-network comprises a convolution layer, a normalization layer, and an activation layer, and when convolution processing is performed on each frame of noisy feature vectors in the convolution layer, reference is made to an adjacent preceding frame of noisy feature vectors, and M is a natural number greater than or equal to 2; and
decode the i^{th} intermediate result by employing the decoding network constructed based on the streaming convolution structure, to obtain the i^{th} noise reduction result comprises:
decode the i^{th} intermediate result by employing M decoding sub-networks having a connection relationship in the decoding network to obtain the i^{th} noise reduction result, wherein each decoding sub-network comprises a transposed convolution layer associated with the convolution layer, a normalization layer, and an activation layer, wherein a hopping connection is set between a kth encoding sub-network and a (M−(k−1))^{th} decoding sub-network, and k is a natural number greater than or equal to 1 and less than or equal to M.

15. The audio noise reduction processing apparatus according to claim 14, during decode the i^{th} intermediate result by employing the M decoding sub-networks having the connection relationship in the decoding network to obtain the i^{th} noise reduction result, further comprising:
perform weighted summation processing respectively on output results respectively corresponding to the M encoding sub-networks in the encoding network in the i^{th} noise reduction branch and M gated processing results associated with an (i−1)^{th} noise reduction branch when the i^{th} noise reduction branch is not a first noise reduction branch, to obtain M decoded reference results, wherein a j^{th} gated processing result is obtained by processing an output result of a j^{th} encoding sub-network in the (i−1)^{th} noise reduction branch by using a j^{th} information transfer gated structure in the audio processing network, the convolution layer in each information transfer gated structure comprises at least two convolution structures, and j is a natural number greater than or equal to 1 and less than or equal to M; and
input each decoded reference result of the M decoded reference results respectively into a corresponding decoding sub-network of the M decoding sub-networks in the i^{th} noise reduction branch.

16. The audio noise reduction processing apparatus according to claim 11, wherein modulate the N branch mask estimation results by employing the noisy frequency domain representation to obtain the N speech frequency domain representations comprises:
concatenate the N branch mask estimation results, to obtain a concatenation expression; and
perform modulation processing on the concatenation expression by employing the noisy frequency domain representation, to obtain a full-band speech frequency domain representation.

17. The audio noise reduction processing apparatus according to claim 16, wherein perform the time domain transformation on the N speech frequency domain representations to obtain the speech signal in the audio signal comprises:
perform time domain transformation on the full-band speech frequency domain representation, to obtain a full-band estimation result of the speech signal.

18. The audio noise reduction processing apparatus according to claim 16, before concatenate the N branch mask estimation results, to obtain the concatenation expression further comprising:
perform the modulation processing on the noisy frequency domain representation of the i^{th} noisy frequency band by employing the i^{th} branch mask estimation result, to obtain an i^{th} speech frequency domain representation; and
perform time domain transformation on the i^{th} speech frequency domain representation, to obtain an i^{th} frequency band estimation result of the speech signal.

19. The audio noise reduction processing apparatus according to claim 11, before perform the frequency domain transformation on the audio signal, to obtain the noisy frequency domain representation corresponding to the audio signal, further comprising:
sample the audio signal according to a target sampling rate, to obtain sampled audio data; and
perform time domain framing processing on the sampled audio data, to obtain a processed audio signal.

20. A non-transitory computer program product, comprising computer-readable instructions, the computer-readable instructions, when executed by a processor, are configured to cause the processor to execute a method, the method comprising:
obtaining an audio signal, the audio signal comprising a to-be-recognized speech signal interfered with by a noise signal;
performing frequency domain transformation on the audio signal to obtain a noisy frequency domain representation corresponding to the audio signal;
dividing the noisy frequency domain representation into N noisy frequency bands
inputting the N noisy frequency bands respectively into N noise reduction branches in an audio processing network, to obtain N branch mask estimation results, an i^{th} noise reduction branch in the audio processing network being configured to process an i^{th} noisy frequency band among the N noisy frequency bands, to obtain an i^{th} branch mask estimation result corresponding to the i^{th} noisy frequency band, the N noise reduction branches having a same signal processing structure, wherein i is a natural number greater than or equal to 1 and less than or equal to N and Nis a natural number greater than 1;
modulating the N branch mask estimation results by employing the noisy frequency domain representation, to obtain N speech frequency domain representations; and
performing time domain transformation on the N speech frequency domain representations, to obtain a speech signal free from noise signal interference in the audio signal.
